(19) United States
(12) Patent Application Publication
(10) Pub. No.: US 2022/0407271 A1
(43) Pub. Date: Dec. 22, 2022

(54) Electrical Connector Housing and Electrical Connector Assembly for Electrically Conductive Structures

(71) Applicant: Lear Corporation, Southfield, MI (US)

(72) Inventors: Edgar Michael Racho, Lapu-Lapu City (PH); Alexzyev Dolumbal, Lapu-Lapu City (PH); Lewis Galligan, Novi, MI (US)

(73) Assignee: Lear Corporation, Southfield, MI (US)

(21) Appl. No.: 17/550,313

(22) Filed: Dec. 14, 2021

Related U.S. Application Data
(63) Continuation-in-part of application No. 17/351,635, filed on Jun. 18, 2021.

(51) Int. Cl. H01R 24/20; H01R 13/432

(52) U.S. Cl. CPC H01R 24/20; H01R 13/432

(57) ABSTRACT

Electrical connector housings and electrical connector assemblies for electrically conductive structures are described. An example electrical connector housing has a base and a cover. The base has a first end, a second end, a passageway, a recess, and a cover recess. The passageway extends from the first end of the base toward the second end of the base. The recess extends from the passageway to the second end of the base. The cover recess is disposed between the passageway and the second end of the base. The cover is moveable between an open position and a closed position relative to the base. The cover has a projection disposed within the cover recess when the cover is in the closed position.

### CROSS-REFERENCE TO RELATED APPLICATIONS

This application is a continuation-in-part of U.S. Nonprovisional application Ser. No. 17/351,635, filed Jun. 18, 2021. The entire disclosure of this related application is hereby incorporated into this disclosure by reference.

### FIELD

The disclosure relates generally to the field of electrical connector housings and electrical connector assemblies that facilitate electrical connections between two electrical conductive structures. More particularly, the disclosure relates to an electrical connector housing and an electrical connector assembly for electrically conductive structures.

### BACKGROUND

Conventionally, electrical systems can include one or more electrically operated devices that are each connected to a source of electrical energy and/or other components of an electrical system by one or more electrical conductors. For example, most automobiles and other vehicles include a variety of electrically operated devices that can be selectively operated for the comfort and convenience of a driver or an occupant. In many instances, electrical connector housings and electrical connector assemblies are provided on the electrical conductors to facilitate the installation, service, and removal of these electrically operated devices to and from the electrical system.

A typical electrical connector assembly includes an outer housing (which is usually formed from an electrically non-conductive material) and an inner electrical terminal (which is usually formed from an electrically conductive material) that is supported within the housing. The inner electrical terminal is used to electrically connect a first electrically conductive structure and a second electrically conductive structure. For example, engagement of the first electrically conductive structure, such as those that include one or more electrical contacts (e.g., one or more electrically conductive pins), with the inner electrical terminal is accomplished by inserting a portion of the first electrically conductive structure into a passageway defined by the inner electrical terminal. Engagement with the second electrically conductive structure with the inner electrical terminal is accomplished by crimping an end of the inner electrical terminal onto a portion of the second electrically conductive structure (e.g., an electrically conductive material). Such crimping is accomplished using of a variety of specialized tools and/or specialized methods. In addition, the outer housings utilized in conventional electrical connector assemblies are limited to being used with only the crimp-style electrical terminal. Thus, it would be desirable to provide an improved structure for an electrical connector housing and an electrical connector assembly that can accomplish a quick and easy connection between two electrically conductive structures and/or utilize various types of electrical terminals.

A need exists, therefore, for new and useful electrical connector housings and electrical connector assemblies for electrically conductive structures.

### SUMMARY

Various example electrical connector housings and electrical connector assemblies for electrically conductive structures are described.

An example electrical connector housing has a base and a cover. The base has a first end, a second end, a passageway, a recess, and a cover recess. The passageway extends from the first end of the base toward the second end of the base. The recess extends from the passageway to the second end of the base. The cover recess is disposed between the passageway and the second end of the base. The cover is moveable between an open position and a closed position relative to the base. The cover has a projection disposed within the cover recess when the cover is in the closed position.

An example electrical connector assembly has an electrical connector housing and an electrical terminal. The electrical connector housing has a base and a cover. The base has a first end, a second end, a passageway, a recess, and a cover recess. The passageway extends from the first end of the base toward the second end of the base. The recess extends from the passageway to the second end of the base. The cover recess is disposed between the passageway and the second end of the base. The cover is moveable between an open position and a closed position relative to the base. The cover has a projection disposed within the cover recess when the cover is in the closed position. The electrical terminal has a terminal head and an electrical contact. The terminal head is disposed within the passageway of the base. The electrical contact is disposed within the recess of the base.

Another example electrical connector assembly has an electrical connector housing, an electrical terminal, and an electrically conductive structure. The electrical connector housing has a base and a cover. The base has a first end, a second end, a passageway, a recess, and a cover recess. The passageway extends from the first end of the base toward the second end of the base. The recess extends from the passageway to the second end of the base. The cover recess is disposed between the passageway and the second end of the base. The cover is moveable between an open position and a closed position relative to the base. The cover has a projection disposed within the cover recess when the cover is in the closed position. The electrical terminal has a terminal head and an electrical contact. The terminal head is disposed within the terminal passageway of the base. The electrical contact is disposed within the terminal recess. The electrical contact extends from the terminal head and has a lengthwise axis and a spring finger contact. The spring finger contact is moveable relative to the terminal head between a first position and a second position. The spring finger contact is in the first position when the cover is in the open position. The spring finger contact is in the second position when the cover is in the closed position. The spring finger contact has a cantilever portion and a contact portion. The cantilever portion extends away from the terminal head and away from the lengthwise axis of the electrical contact. The contact portion extends from the cantilever portion. The electrically conductive structure is disposed within the electrical connector housing between the base and the cover. The electrically conductive structure has an electrically conductive trace surrounded by an electrically non-conductive insulator. The electrically non-conductive insulator has a top layer, an intermediate layer, and a bottom layer. The electrically conductive trace is disposed between the top layer and the bottom layer and contacts the contact portion when the cover is in the closed position.

Additional understanding of these examples can be obtained by review of the detailed description, below, and the appended drawings.

### BRIEF DESCRIPTION OF THE DRAWINGS

FIG. 1 is a perspective view of a first embodiment of an electrical terminal for electrically conductive structures.

FIG. 2 is a side view of the electrical terminal illustrated in FIG. 1.

FIG. 3 is an exploded perspective view of the electrical terminal illustrated in FIG. 1.

FIG. 4 is a side sectional view of the electrical terminal illustrated in FIG. 1 taken along the lengthwise axis of the terminal head.

FIG. 5 is a perspective sectional view of a first embodiment of an electrical connector assembly for electrically conductive structures. The electrical connector assembly includes the electrical terminal illustrated in FIG. 1 and a first embodiment of an electrical connector housing. The cover of the electrical connector housing is shown in an open position.

FIG. 6 is a partial side sectional view of the electrical connector assembly illustrated in FIG. 5 and an electrically conductive structure. The electrically conductive structure is partially disposed within the electrical connector housing and the cover of the electrical connector housing is shown in an open position.

FIG. 7 is another partial side sectional view of the electrical connector assembly illustrated in FIG. 5 and an electrically conductive structure. The electrically conductive structure is partially disposed within the electrical connector housing and the cover of the electrical connector housing is shown in a closed position.

FIG. 8 is a perspective view of a second embodiment of an electrical terminal for electrically conductive structures.

FIG. 9 is a side view of the electrical terminal illustrated in FIG. 8.

FIG. 10 is a perspective sectional view of a second embodiment of an electrical connector assembly for electrically conductive structures. The electrical connector assembly includes the electrical terminal illustrated in FIG. 8 and the first embodiment of the electrical connector housing. The cover of the electrical connector housing is shown in an open position.

FIG. 11 is a partial side sectional view of the electrical connector assembly illustrated in FIG. 10 and an electrically conductive structure. The electrically conductive structure is partially disposed within the electrical connector housing and the cover of the electrical connector housing is shown in an open position.

FIG. 12 is another partial side sectional view of the electrical connector assembly illustrated in FIG. 10 and an electrically conductive structure. The electrically conductive structure is partially disposed within the electrical connector housing and the cover of the electrical connector housing is shown in a closed position.

FIG. 13 is a perspective view of a third embodiment of an electrical terminal for electrically conductive structures.

FIG. 14 is a side view of the electrical terminal illustrated in FIG. 13.

FIG. 15 is a partial perspective sectional view of a third embodiment of an electrical connector assembly for electrically conductive structures and an electrically conductive structure. The electrical connector assembly includes the electrical terminal illustrated in FIG. 13 and a second embodiment of an electrical connector housing. The electrically conductive structure is partially disposed within the electrical connector housing and the cover of the electrical connector housing is shown in an open position.

FIG. 16 is a partial perspective view of the electrical connector assembly illustrated in FIG. 15 and an electrically conductive structure. The electrically conductive structure is partially disposed within the electrical connector housing and the cover of the electrical connector housing is shown in a closed position.

FIG. 17 is a partial side sectional view of the electrical connector assembly illustrated in FIG. 15 and an electrically conductive structure. The electrically conductive structure is partially disposed within the electrical connector housing and the cover of the electrical connector housing is shown in an open position.

FIG. 18 is another partial side sectional view of the electrical connector assembly illustrated in FIG. 15 and an electrically conductive structure. The electrically conductive structure is partially disposed within the electrical connector housing and the cover of the electrical connector housing is shown in a closed position.

FIG. 19 is a perspective view of a third embodiment of an electrical connector housing. The cover of the electrical connector housing is shown in an open position.

FIG. 20 is a side sectional view of the electrical connector housing illustrated in FIG. 19. The cover of the electrical connector housing is shown in an open position.

FIG. 21 is another side sectional view of the electrical connector housing illustrated in FIG. 19. The cover of the electrical connector housing is shown in a closed position.

FIG. 22 is a perspective view of a fourth embodiment of an electrical connector assembly for electrically conductive structures. The electrical connector assembly includes the electrical terminal illustrated in FIG. 13 and the third embodiment of an electrical connector housing illustrated in FIG. 19. The cover of the electrical connector housing is shown in an open position.

FIG. 23 is a partial perspective view of the electrical connector assembly illustrated in FIG. 22 and a first electrically conductive structure. The electrically conductive structure is partially disposed within the electrical connector housing and the cover of the electrical connector housing is shown in an open position.

FIG. 24 is a partial side sectional view of the electrical connector assembly illustrated in FIG. 22, a first electrically conductive structure, and a second electrically conductive structure. The first electrically conductive structure and the second electrically conductive structure are partially disposed within the electrical connector housing and the cover of the electrical connector housing is shown in a closed position.

FIG. 25 is a perspective view of a conventional electrical terminal for electrically conductive structures.

FIG. 26 is a partial perspective view of a fifth embodiment of an electrical connector assembly for electrically conductive structures and a plurality of electrically conductive structures. The electrical connector assembly includes the electrical terminal illustrated in FIG. 25 and the third embodiment of an electrical connector housing illustrated in FIG. 19. Each electrically conductive structure of the plurality of electrically conductive structures is partially disposed within the electrical connector housing. The cover of the electrical connector housing is shown in a closed position.

FIG. 27 is a partial side sectional view of the electrical connector assembly illustrated in FIG. 26 and a first electrically conductive structure. A first electrical terminal is partially disposed within the electrical connector housing and the cover of the electrical connector housing is shown in a closed position.

FIG. 28 is another partial side sectional view of the electrical connector assembly illustrated in FIG. 26, a first electrically conductive structure, and a second electrically conductive structure. A first electrical terminal is entirely disposed within the electrical connector housing and the first electrically conductive structure and the second electrically conductive structure are partially disposed within the electrical connector housing. The cover of the electrical connector housing is shown in a closed position.

FIG. 29 is another partial perspective view of the fifth embodiment of an electrical connector assembly illustrated in FIG. 26 and a plurality of electrically conductive structures. Each electrically conductive structure of the plurality of electrically conductive structures is partially disposed within the electrical connector housing. The cover of the electrical connector housing is shown in an open position.

FIG. 30 is a partial side sectional view of the fifth embodiment of an electrical connector assembly illustrated in FIG. 29 and a first electrically conductive structure. A first electrical terminal is entirely disposed within the electrical connector housing and the first electrically conductive structure is partially disposed within the electrical connector housing. The cover of the electrical connector housing is shown in an open position.

FIG. 31 is another partial side sectional view of the fifth embodiment of an electrical connector assembly illustrated in FIG. 29 and a first electrically conductive structure. A first electrical terminal is entirely disposed within the electrical connector housing and the first electrically conductive structure is partially disposed within the electrical connector housing. The cover of the electrical connector housing is shown in a closed position.

FIG. 32 is a perspective view of a fourth embodiment of an electrical connector housing. The cover of the electrical connector housing is shown in an open position.

FIG. 33 is an end view of the electrical connector housing illustrated in FIG. 32. The cover of the electrical connector housing is shown in an open position.

FIG. 34 is a top view of the electrical connector housing illustrated in FIG. 32. The cover of the electrical connector housing is shown in an open position.

FIG. 35 is a side sectional view of the electrical connector housing illustrated in FIG. 32. The cover of the electrical connector housing is shown in an open position.

FIG. 36 is a partial perspective view of a sixth embodiment of an electrical connector assembly for electrically conductive structures, a first electrically conductive structure, a second electrically conductive structure, and a third electrically conductive structure. The electrical connector assembly includes the electrical terminal illustrated in FIG. 13 and the fourth embodiment of an electrical connector housing illustrated in FIG. 32. The cover of the electrical connector housing is shown in an open position.

FIG. 37 is a partial perspective view of the first electrically conductive structure illustrated in FIG. 36 free of the electrical connector assembly.

### DETAILED DESCRIPTION

The following detailed description and the appended drawings describe and illustrate various example embodiments of electrical connector housings and electrical connector assemblies for electrically conductive structures. The description and illustration of these examples are provided to enable one skilled in the art to make and use an electrical connector housing and an electrical connector assembly according to this invention. They are not intended to limit the scope of the claims in any manner.

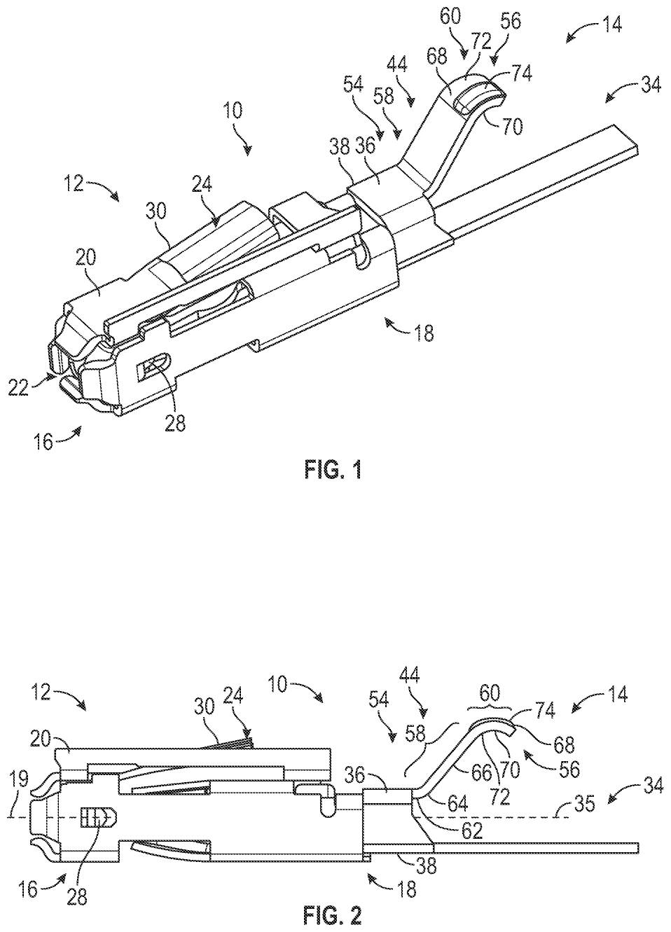

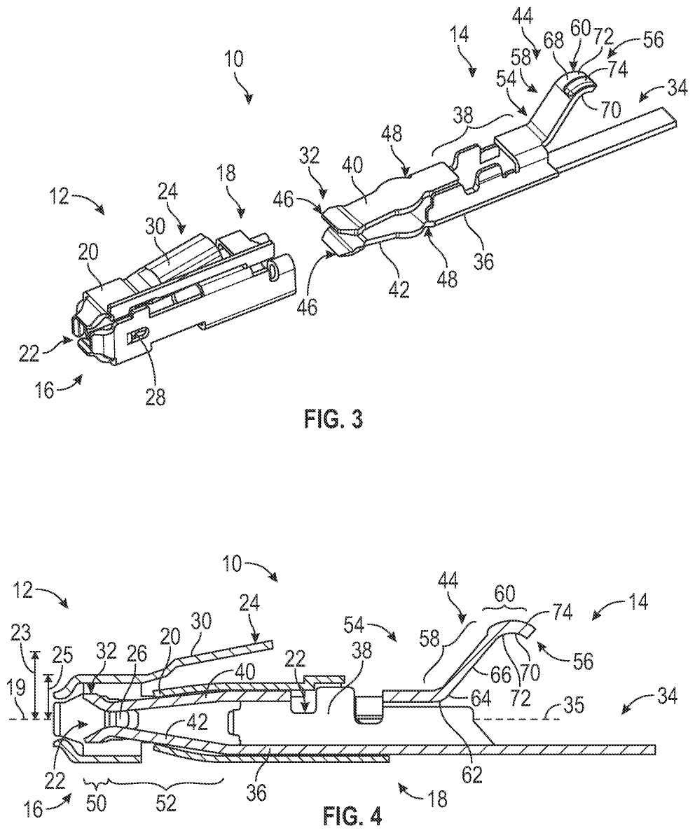

FIGS. 1, 2, 3, and 4 illustrate a first embodiment of an electrical terminal 10 that has a terminal head 12 and an electrical contact 14. The terminal head 12 has a first end 16, a second end 18, a lengthwise axis 19, a main body 20 that defines a passageway 22, a retaining member 24, a first projection 26, and a second projection 28. The passageway 22 extends from the first end 16 to the second end 18 and is adapted to receive the electrical contact 14 and a portion of an electrically conductive structure (e.g., an electrically conductive pin of an electrically conductive structure). The retaining member 24 is adapted to accomplish attachment of the terminal head 12 to an electrical connector housing, as described herein. Any suitable retaining member can be included on a terminal head. In the illustrated embodiment, the retaining member 24 is a retaining projection 30 that extends from the main body 20 of the terminal head 12, away from the lengthwise axis 19, and toward the second end 18. The retaining projection 30 is moveable between a first position, as shown in FIGS. 1 through 4, and a second position. The retaining projection 30 is disposed a first distance 23 from the lengthwise axis 19 in the first position, as shown in FIG. 4, and is disposed a second distance 25 from the lengthwise axis 19 in the second position, as described in more detail herein. The second distance 25 is less than the first distance 23. The retaining projection 30 is biased to the first position such that attachment to an electrical connector housing can be achieved. Each of the first and second projections 26, 28 extends into the passageway 22 and is adapted to be disposed between the first and second retaining arms 40, 42 of the electrical contact 14, as described in more detail herein, to accomplish attachment of the electrical contact 14 to the terminal head 12. While projections 26, 28 have been illustrated as accomplishing attachment between an electrical contact and a terminal head, any other structure can be used to accomplish such attachment.

The electrical contact 14 extends from the terminal head 12 and has a first end 32, a second end 34, a lengthwise axis 35, and a main body 36 that defines a base 38, a first retaining arm 40, a second retaining arm 42, and a spring finger contact 44. Each of the first and second retaining arms 40, 42 extends from the base 38, to the first end 16 of the terminal head 12, and is disposed within the passageway 22 defined by the terminal head 12. Each of the first and second retaining arms 40, 42 has a first end 46 and a second end 48 attached to the base 38. As shown in FIG. 4, the first and second retaining arms 40, 42 cooperatively define a tapered region 50 and a flared region 52 between the first and second retaining arms 40, 42. The tapered region 50 extends from the first end 32 of the electrical contact 14 toward the second end 34 of the electrical contact 14. The tapered region 50 also extends from the first end 46 of each of the first and second retaining arms 40, 42 toward the second end 48 of each of the first and second retaining arms 40, 42. The flared region 52 extends from the tapered region 50 toward the second end 34 of the electrical contact 14. The flared region 52 also extends from the tapered region 50 toward the second end 48 of each of the first and second retaining arms 40, 42. As shown in FIG. 4, each of the first and second retaining arms 40, 42 is disposed between, and contacts, the main body 20 of the terminal head 12 and the first and second projections 26, 28 such that the first and second projections 26, 28 are disposed between the first and second retaining arms 40, 42 within the flared region 52.

The spring finger contact 44 is moveable relative to the terminal head 12 and the base 38 of the electrical contact 14 upon the application of an external force on the spring finger contact 44. The spring finger contact 44 has a first end 54, a second end 56, a cantilever portion 58, and a contact portion 60. The cantilever portion 58 extends from the base 38, away from the terminal head 12, away from the first end 32 of the electrical contact 14, and away from the lengthwise axis 35 of the electrical contact 14. In the illustrated embodiment, as shown in FIGS. 2 and 4, the cantilever portion 58 has a first, linear portion 62, a second, curved portion 64, and a third, linear portion 66. However, alternative embodiments can include a cantilever portion that has any suitable structural arrangement, such as those that omit the inclusion of a first, linear portion, a second, curved portion, or a third, linear portion. The first, linear portion 62 extends from the first end 54 of the spring finger contact 44, away from the terminal head 12, and to the second, curved portion 64. The second, curved portion 64 extends from the first, linear portion 62, away from the lengthwise axis 35 of the electrical contact 14, to the third, linear portion 66. The third, linear portion 66 extends from the second, curved portion 64, away from the lengthwise axis 35 of the electrical contact 14, and to the contact portion 60. The contact portion 60 extends from the cantilever portion 58, away from the terminal head 12, and away from the first end 32 of the electrical contact 14. In the illustrated embodiment, as shown in FIGS. 2 and 4, the contact portion 60 has a first surface 68, a second surface 70, a fourth, curved portion 72, and a protuberance 74. The first surface 68 opposably faces the second surface 70. The fourth, curved portion 72 extends from the third, linear portion 66 to the second end 56 of the spring finger contact 44 and toward the lengthwise axis 35 of the electrical contact 14. The protuberance 74 extends from the first surface 68 and away from the second surface 70. While a protuberance has been shown as included on a contact portion of a spring finger contact, alternative embodiments can omit the inclusion of a protuberance.

While the terminal head 12 and electrical contact 14 have been illustrated as having a particular structural arrangement, a terminal head and an electrical contact included in an electrical terminal can have any suitable structural arrangement and be formed of any suitable material. Selection of a suitable structural arrangement and material to form a terminal head and/or an electrical contact can be based on various considerations, including the intended use of the electrical terminal. Examples of materials considered suitable to form a terminal head and/or an electrical contact include electrically conductive materials.

In the illustrated embodiment, the electrical contact 14 is a separate component that is attached to the terminal head 12. However, alternative embodiments can include a terminal head and an electrical contact that are formed from a single piece of material. When formed as two separate components, as shown in FIGS. 1, 2, 3, and 4, the first end 32 of the electrical contact 14 is aligned with the second end 18 and the passageway 22 defined by the terminal head 12. An axial force is applied to one or both of the terminal head 12 and the electrical contact 14 directed toward the other component or each other such that the first and second retaining arms 40, 42 are advanced into the passageway 22 defined by the terminal head 12 and the first and second projections 26, 28 of the terminal head 12 are advanced through the tapered region 50 and into the flared region 52 of the electrical contact 14. The position of the first and second projections 26, 28 relative to the main body 20 of the terminal head 12 forces each of the first and second retaining arms 40, 42 between the main body 20 and the first and second projections 26, 28 accomplishing attachment between the terminal head 12 and the electrical contact 14. While attachment between the terminal head 12 and the electrical contact 14 has been illustrated as being accomplished using the main body 30 of the terminal head 12 and the first and second projections 26, 28, any suitable structure and/or attachment member can be used to accomplish attachment between a terminal head and an electrical contact.

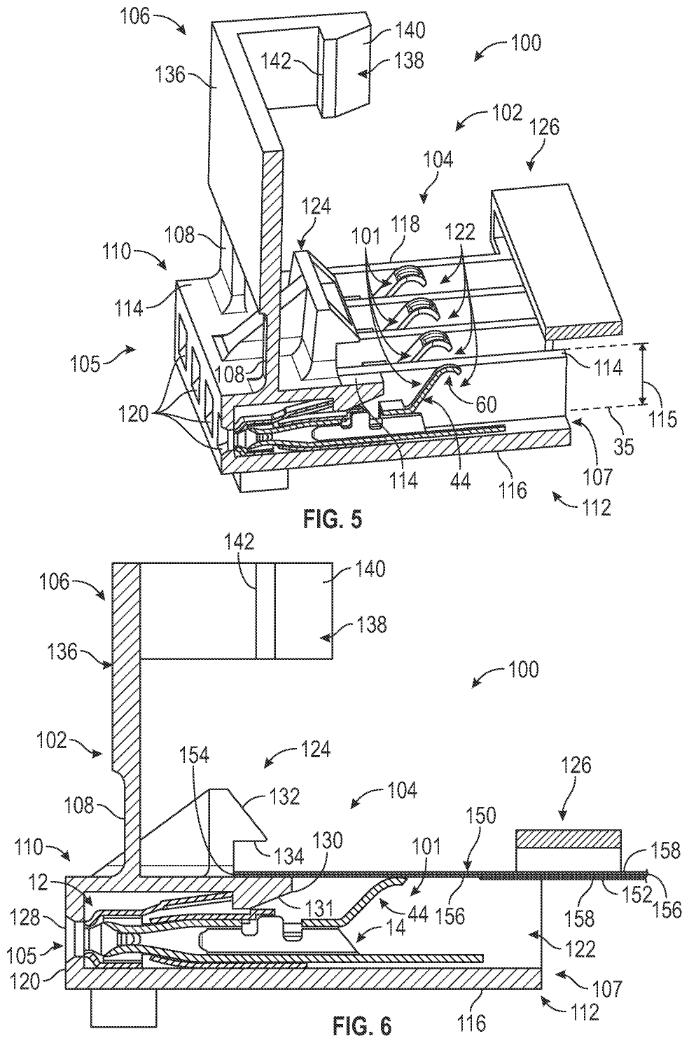

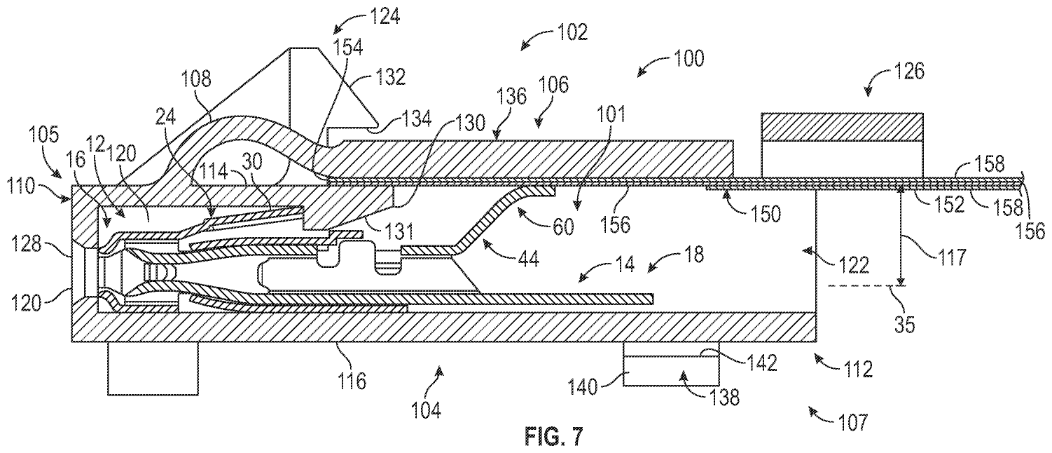

FIGS. 5, 6, and 7 illustrate a first embodiment of an electrical connector assembly 100 that includes a plurality of electrical terminals 101 housed within an electrical connector housing 102. The electrical connector housing 102 has a first end 105, a second end 107, a base 104, and a cover 106. The cover 106 is moveable between an open position, as shown in FIGS. 5 and 6, and a closed position, as shown in FIG. 7, relative to the base 104. A cover included in an electrical connector housing 102 can be moveable relative to a base using any suitable structure. In the illustrated embodiment, the cover 106 is attached to the base 104, and pivotable relative to the base 104, using a plurality of living hinges 108. However, alternative embodiments can include a cover as a separate component that can be releasably attached to a base.

The base 104 has a first end 110, a second end 112, a top 114, a bottom 116, a first side 118, a plurality of passageways 120, a plurality of recesses 122, a locking member 124, and a retention arm 126. While the second side has not been illustrated in FIGS. 5, 6, and 7, FIG. 16 shows an example of a second side of a base of an electrical connector housing. Each passageway of the plurality of passageways 120 extends from the first end 105 of the electrical connector housing 102 toward the second end 107 of the electrical connector housing 102. Each passageway of the plurality of passageways 120 extends from a first opening 128 on the first end 110 of the base 104 to a second opening 130 that is in communication with a recess of the plurality of recesses 122. A retaining member projection 131 extends into each passageway of the plurality of passageways 120 and assists with attachment of an electrical terminal of the plurality of electrical terminals 101 to the base 104, as described herein. Each recess of the plurality of recesses 122 extends from the second end 112 of the base 104 toward the first end 110 of the base 104 to a passageway of the plurality of passageways 120 and from the top 114 of the base 104 toward the bottom 116 of the base 104. However, alternative embodiments can include a recess that extends from a location between a second end of a base and a first end of the base toward the first end of the base. Each passageway of the plurality of passageways 120 is adapted to receive a portion of an electrical terminal of the plurality of electrical terminals 101 and each recess of the plurality of recesses 122 is adapted to receive a portion of the electrical terminal of the plurality of electrical terminals 101. This structural arrangement results in a first portion of an electrical terminal of the plurality of electrical terminals 101 being is disposed within a passageway of the plurality of passageways 120 and a second portion of the electrical terminal of the plurality of electrical terminals 101 being is disposed within a recess of the plurality of recesses 122. The locking member 124 extends from the top 114 of the base 104 and away from the bottom 116 of the base 104 and defines a tapered projection 132 and a shoulder 134. The retention arm 126 extends from the first side 118 of the base 104, over the top 114 of the base 104, over the plurality of recesses 122, and to the second side and provides a mechanism for maintaining the position of an electrically conductive structure relative to the base 104, as described in more detail herein.

While the base 104 has been illustrated as including a plurality of passageways 120 and a plurality of recesses 122 having a particular structural arrangement, a base of an electrical connector housing can include any suitable number of passageways and recesses having any suitable structural arrangement. Selection of a suitable structural arrangement for a passageway and a recess, and of a suitable number of passageways and recesses, to include in an electrical connector housing can be based on various considerations, such as the intended use of the electrical connector housing. Examples of numbers of passageways and recesses considered suitable to include in an electrical connector housing include one, more than one, two, a plurality, three, four, five, more than five, and any other number considered suitable for a particular embodiment. In the illustrated embodiment, the plurality of passageways 120 includes four passageways and the plurality of recesses 122 includes four recesses.

In the illustrated embodiment, the cover 106 is pivotably attached to the base 104 and has a main body 136 and a locking member 138. The main body 136 is adapted to be disposed between the locking member 124 of the base 104 and the top 114 of the base 104 and is adapted to clamp a portion of an electrically conductive structure between the main body 136 and the base 104 when the cover 106 is in the closed position. The locking member 138 extends from the main body 136 and beyond the bottom 116 of the base 104 when the cover 106 is in the closed position and defines a tapered projection 140 and a shoulder 142.

An electrical connector housing included in an electrical connector assembly can have any suitable structural arrangement and be formed of any suitable material and selection of a suitable structural arrangement and material to form an electrical connector housing can be based on various considerations, including the intended use of the electrical connector assembly. Examples of materials considered suitable to form an electrical connector housing include electrically non-conductive materials.

Each electrical terminal of the plurality of electrical terminals 101 is housed within, and attached to, the electrical connector housing 102. In the illustrated embodiment, each electrical terminal of the plurality of electrical terminals 101 is similar to the electrical terminal 10 illustrated in FIGS. 1, 2, 3, and 4. However, other electrical terminals, such as the alternative embodiments described herein, can be housed within an electrical connector housing. Each electrical terminal of the plurality of electrical terminals 101 is positioned within the electrical connector housing 102 such that the terminal head 12 is disposed within a passageway of the plurality of passageways 120 and the electrical contact 14 is disposed within a recess of the plurality of recesses 122. As shown in FIG. 5, the spring finger contact 44 is positioned such that it is partially disposed within a recess of the plurality of recesses 122, partially extends beyond the boundaries of the recess of the plurality of recesses 122, and partially extends beyond the top 114 of the base 104 when in the first position. This structural arrangement allows the spring finger contact 44 to contact an electrically conductive structure, as described in more detail herein.

Any suitable number of electrical terminals can be included in an electrical connector housing and selection of a suitable number of electrical terminals to include in an electrical connector housing can be based on various considerations, including the number of electrically conductive traces, such as those described below, that are included in an electrically conductive structure intended to be attached to the electrical connector housing. Examples of numbers of electrical terminals considered suitable to include in an electrical connector housing include one, more than one, two, a plurality, three, four, five, more than five, a number that is the same as the number of passageways defined by a base of an electrical connector housing, a number that is the same as the number of electrically conductive traces provided on an electrically conductive structure, and any other number considered suitable for a particular embodiment. In the illustrated embodiment, the plurality of electrical terminals 101 includes four electrical terminals.

To position an electrical terminal of the plurality of electrical terminals 101 within the electrical connector housing 102, the first end 16 of the terminal head 12 is aligned with the second opening 130 of a passageway of the plurality of passageways 120 defined by the base 104. An axial force is applied to one or both of the electrical terminal of the plurality of electrical terminals 101 and the electrical connector housing 102 directed toward the other component or each other such that the terminal head 12 is advanced into the passageway of the plurality of passageways 120 defined by the base 104 and the retaining member 24 of the terminal head 12 is disposed between the retaining member projection 131 and the first end 110 of the base 104. In the illustrated embodiment, the retaining projection 30 moves from the first position to the second position (e.g., deflects) as the terminal head 12 moves relative to the electrical connector housing 102 and into the passageway of the plurality of passageways 120. Subsequently, after the retaining projection 30 is advanced to a position in which it is disposed between the retaining member projection 131 and the first end 110 of the base 104, the retaining projection 30 moves back to the first position as a result of its bias to the first position.

As shown in FIGS. 6 and 7, an electrically conductive structure 150 can be positioned between the base 104 and the cover 106 and attached (e.g., releasably) to the electrical connector housing 102. An electrically conductive structure used with in an electrical connector assembly can have any suitable structural arrangement and be formed of any suitable material and selection of a suitable structural arrangement and material to form an electrically conductive structure can be based on various considerations, including the intended use of the electrical connector assembly. In the illustrated embodiment, the electrically conductive structure 150 is a flat flexible connector 152 that has an end 154 and one or more electrically conductive traces 156 that are surrounded by an outer electrically non-conductive insulator 158. As discussed above, most automobiles and other vehicles include a variety of electrically operated devices that can be selectively operated for the comfort and convenience of a driver or an occupant. Typically, each of these electrically operated devices is connected to a source of electrical energy and/or other components of the electrical system by one or more electrical conductors. The electrically conductive traces 156 of the electrically conductive structure 150 can be used for this purpose.

In the illustrated embodiment, the electrically conductive structure 150 includes four electrically conductive traces 156. However, an electrically conductive structure can include any suitable number of electrically conductive traces, such as a number of electrically conductive traces that is the same as the number of electrical terminals included in an electrical connector assembly. For a reason that will become apparent below, a portion of the electrically non-conductive insulator 158 is removed adjacent to, or near, the end 154 of the electrically conductive structure 150 so as to expose the electrically conductive traces 156.

In use, and while the cover 106 is in the open position, the electrically conductive structure 150 is positioned on the base 104 of the electrical connector housing 102 such that each of the electrically conductive traces 156 is disposed adjacent to a spring finger contact 44 of an electrical terminal of the plurality of electrical terminals 101. In the embodiment illustrated, the electrically conductive structure 150 is positioned on the base 104 such that the end 154 of the electrically conductive structure 150 contacts, or is adjacent to, the locking member 124 of the base 104. Subsequently, the cover 106 of the electrical connector housing 102 is moved from the open position to the closed position such that the main body 136 of the cover 106 advances along the tapered projection 132 of the locking member 124 of the base 104 until it is positioned between the shoulder 134 defined by the locking member 124 and the top 114 of the base 104. In addition, when the cover 106 is moved from the open position to the closed position, the tapered portion 140 of the locking member 138 of the cover 106 advances along the base 104 until the base is positioned between the shoulder 142 and the main body 136 of the cover 106. As shown in FIG. 7, when the cover 106 is in the closed position, the electrically conductive structure 150 is flat, or planar, between the base 104 and the cover 106 and each of the electrically conductive traces 156 contacts a contact portion 60 of an electrical terminal of the plurality of electrical terminals 101.

As described herein, the spring finger contact 44 is moveable relative to the terminal head 12 and the base 38 of the electrical contact 14 upon the application of an external force on the spring finger contact 44. When the cover 106 is in the open position, as shown in FIG. 5, the spring member contact 44 is in a first position and extends beyond the top 114 of the base 104 such that the contact portion 60 is disposed a first distance 115 from the lengthwise axis 35 of the electrical contact 14. When the cover 106 is in the closed position, as shown in FIG. 7, the spring member contact 44 is in a second position, is compressed between the bae 104 and the cover 106, and the contact portion 60 is disposed a second distance 117 from the lengthwise axis 35 of the electrical contact 14 that is less than the first distance 115. As a result of the spring finger contact 44 being biased to the first position, when the cover 106 is in the closed position, the spring finger contact 44 contacts and engages a trace of the electrically conductive traces 156 to accomplish an electrically conductive connection between the trace and the electrical contact 14. Subsequently, a second electrically conductive structure, such as those that include one or more electrical contacts (e.g., one or more electrically conductive pins), can be advanced into the passageway 22 of the terminal head 12 from the first end 16 of the terminal head 12 toward the second end 18 of the terminal head 12 until the second electrically conductive structure contacts a portion of the terminal head 12 and/or electrical contact 14 (e.g., first retaining arm 40 and/or second retaining arm 42) to accomplish an electrically conductive connection between the electrical terminal of the plurality of electrical terminals 101 and the second electrically conductive structure. When the cover 106 is moved from the closed position to the open position, and the electrically conductive structure 150 is withdrawn from the electrical connector housing 102, the spring finger contact 44 moves from its second position to its first position such that it is disposed beyond the top 114 of the base 104 and the contact portion 60 is disposed a first distance 115 from the lengthwise axis 35 of the electrical contact 14.

The illustration of any component, element, or feature as being disposed above, below, left of, or right of another component, element, or feature is only with reference to the relative location of the components, elements, and features as shown in the figures in order to aid in describing the electrical connector housings and electrical connector assemblies. Accordingly, the components, elements, or features illustrated and described herein can be oriented in any manner desired without departing from the spirit or scope of the invention.

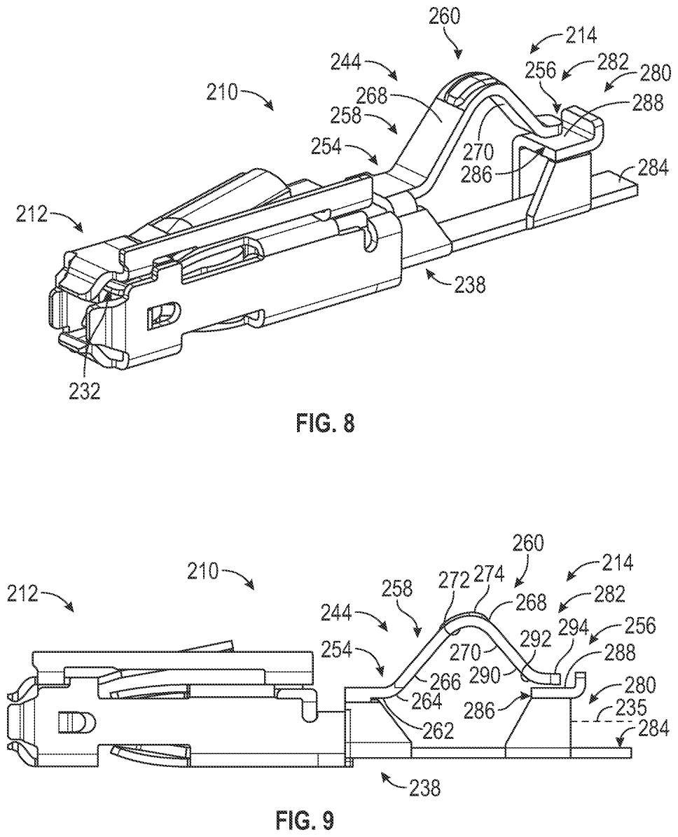

FIGS. 8 and 9 illustrate a second embodiment of an electrical terminal 210 that has a terminal head 212 and an electrical contact 214. In the illustrated embodiment, the electrical contact 214 has a support 280 and the spring finger contact 244 has a tail portion 282 that extends from the contact portion 260. The tail portion 282 contacts the support 280 when the spring finger contact 244 is in the second position, as described in more detail below.

The support 280 has an elongate member 284, a platform 286, and contact surface 288. The elongate member 284 extends from the base 238 of the electrical contact 214 and away from the first end 232 of the electrical contact 214. The platform 286 extends from the elongate member 284 and toward the spring finger contact 244. The contact surface 288 is defined on the platform 286 and is adapted to receive a portion of the spring finger contact 244 (e.g., the tail portion 282).

In the illustrated embodiment, the spring finger contact 244 has a first end 254, a second end 256, a cantilever portion 258, a contact portion 260, a first surface 268, a second surface 270, and a tail portion 282. The first surface 268 opposably faces the second surface 270.

The cantilever portion 258 extends from the base 238, away from the terminal head 212, away from the first end 232 of the electrical contact 214, and away from the lengthwise axis 235 of the electrical contact 214. In the illustrated embodiment, the cantilever portion 258 has a first, linear portion 262, a second, curved portion 264, and a third, linear portion 266. The first, linear portion 262 extends from the first end 254 of the spring finger contact 244, away from the base 238, and to the second, curved portion 264. The second, curved portion 264 extends from the first, linear portion 262, away from the lengthwise axis 235 of the electrical contact 214, and to the third, linear portion 266. The third, linear portion 266 extends from the second, curved portion 264, away from the lengthwise axis 235 of the electrical contact 214, and to the contact portion 260. The contact portion 260 extends from the cantilever portion 258 and away from the terminal head 212. In the illustrated embodiment, the contact portion 260 has a fourth, curved portion 272 and a protuberance 274. The fourth, curved portion 272 extends from the third, linear portion 266 toward the lengthwise axis 235 of the electrical contact 214 to the tail portion 282 of the spring finger contact 244. The protuberance 274 extends from the first surface 268 and away from the second surface 270.

The tail portion 282 extends from the contact portion 260, toward the lengthwise axis 235 of the electrical contact 214, and toward the support 280 (e.g., the platform 286) to the second end 256. In the illustrated embodiment, the tail portion 282 has a fifth, linear portion 290, a sixth, curved portion 292, and a seventh, linear portion 294. The fifth, linear portion 290 extends from the fourth, curved portion 272 of the contact portion 260, away from the terminal head 212, toward the lengthwise axis 235 of the electrical contact 214, and toward the support 280 (e.g., the platform 286) to the sixth, curved portion 292. The sixth, curved portion 292 extends from the fifth, linear portion 290, toward the lengthwise axis 235 of the electrical contact 214, and to the seventh, linear portion 294. The seventh, linear portion 294 extends from the sixth, curved portion 292, away from the terminal head 212, toward the lengthwise axis 235 of the electrical contact 214, and toward the support 280 (e.g., the platform 286) to the second end 256. In the embodiment illustrated, the spring finger contact 244 is free of contact with the support 280 (e.g., platform 286) when the spring finger contact 244 is in the first position, as shown in FIG. 9, and the spring finger contact 244 contacts the support 280 (e.g., platform 286) when the spring finger contact 244 is in the second position, as shown in FIG. 11, as described in more detail below. However, alternative embodiments can include a spring finger contact that contacts a support (e.g., a platform) when in the first position and the second position.

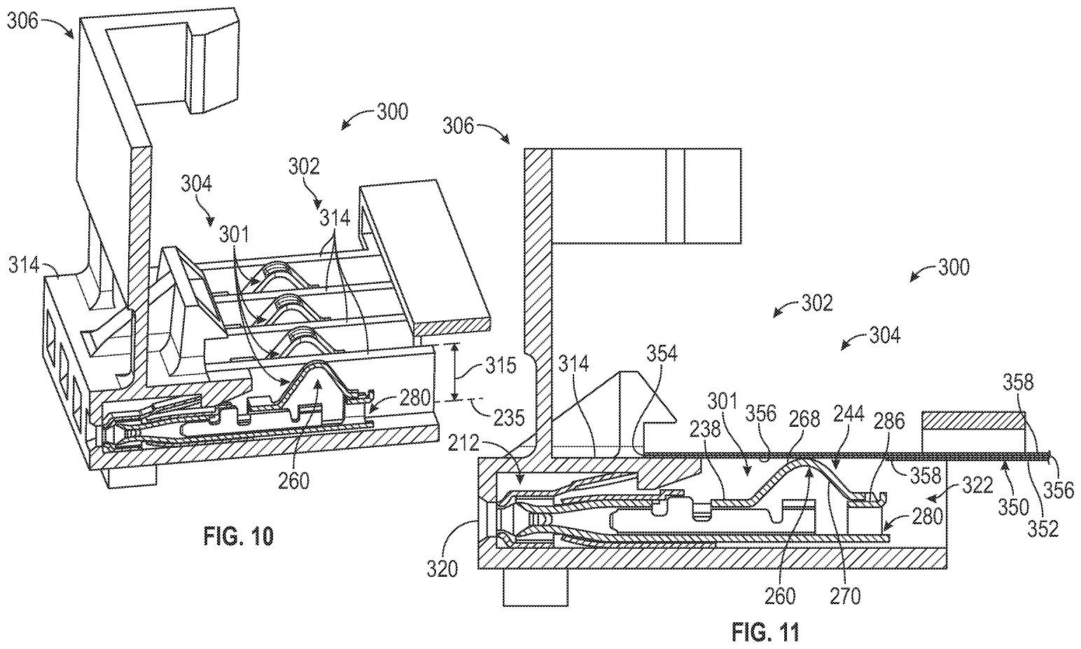

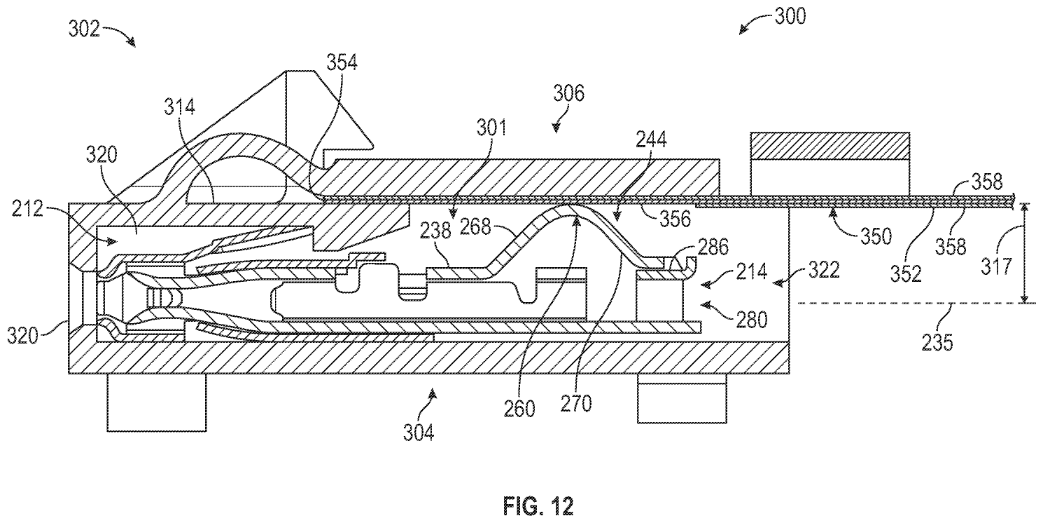

FIGS. 10 through 12 illustrate a second embodiment of an electrical connector assembly 300 that includes a plurality of electrical terminals 301 housed within an electrical connector housing 302. The electrical connector housing 302 is similar to the electrical connector housing 102 illustrated in FIGS. 5 through 7 and has a base 304 and a cover 306. The cover 306 is moveable between an open position, as shown in FIGS. 10 and 11, and a closed position, as shown in FIG. 12.

Each electrical terminal of the plurality of electrical terminals 301 is housed within, and attached to, the electrical connector housing 302. In the illustrated embodiment, each electrical terminal of the plurality of electrical terminals 301 is similar to the electrical terminal 210 illustrated in FIGS. 8 and 9. Each electrical terminal of the plurality of electrical terminals 301 is positioned within the electrical connector housing 302 such that the terminal head 212 is disposed within a passageway of the plurality of passageways 320 and the electrical contact 214 is disposed within a recess of the plurality of recesses 322. As shown in FIG. 10, the spring finger contact 244 is positioned such that it is partially disposed within a recess of the plurality of recesses 322, partially extends beyond the boundaries of the recess of the plurality of recesses 322, and partially extends beyond the top 314 of the base 304 when in the first position. This structural arrangement allows the spring finger contact 244 to contact an electrically conductive structure, as described in more detail herein.

As shown in FIGS. 11 and 12, an electrically conductive structure 350 can be positioned between the base 304 and the cover 306 and attached (e.g., releasably) to the electrical connector housing 302. In the illustrated embodiment, the electrically conductive structure 350 is a flat flexible connector 352 that has an end 354 and one or more electrically conductive traces 356 that are surrounded by an outer electrically non-conductive insulator 358. A portion of the electrically non-conductive insulator 358 is removed adjacent to, or near, the end 354 of the electrically conductive structure 350 so as to expose the electrically conductive traces 356.

In use, and while the cover 306 is in the open position, the electrically conductive structure 350 is positioned on the base 304 of the electrical connector housing 302 such that each of the electrically conductive traces 356 is disposed adjacent to a spring finger contact 244 of an electrical terminal of the plurality of electrical terminals 301. Subsequently, the cover 306 of the electrical connector housing 302 is moved from the open position to the closed position. As described herein, the spring finger contact 244 is moveable relative to the terminal head 212 and the base 238 of the electrical contact 214 upon the application of an external force on the spring finger contact 244. When the cover 306 is in the open position, as shown in FIGS. 10 and 11, the spring member contact 244 is in a first position and extends beyond the top 314 of the base 304 such that the contact portion 260 is disposed a first distance 315 from the lengthwise axis 235 of the electrical contact 214. When the cover 306 is in the closed position, as shown in FIG. 12, the spring member contact 244 is in a second position, is compressed between the base 304 and the cover 306, and the contact portion 260 is disposed a second distance 317 from the lengthwise axis 235 of the electrical contact 214 that is less than the first distance 315. As a result of the spring finger contact 244 being biased to the first position, when the cover 306 is in the closed position, the spring finger contact 244 contacts and engages a trace of the electrically conductive traces 356 to accomplish an electrically conductive connection between the trace and the electrical contact 214. As shown in FIG. 12, when the cover 306 is in the closed position, the first surface 268 of the spring finger contact 244 contacts the electrically conductive trace 356 of the electrically conductive structure 350 and the second surface 270 contacts the support 280 (e.g., platform 286). When the cover 306 is moved from the closed position to the open position, and the electrically conductive structure 350 is withdrawn from the electrical connector housing 302, the spring finger contact 244 moves from its second position to its first position such that it is disposed beyond the top 314 of the base 304 and the contact portion 260 is disposed a first distance 315 from the lengthwise axis 235 of the electrical contact 214.

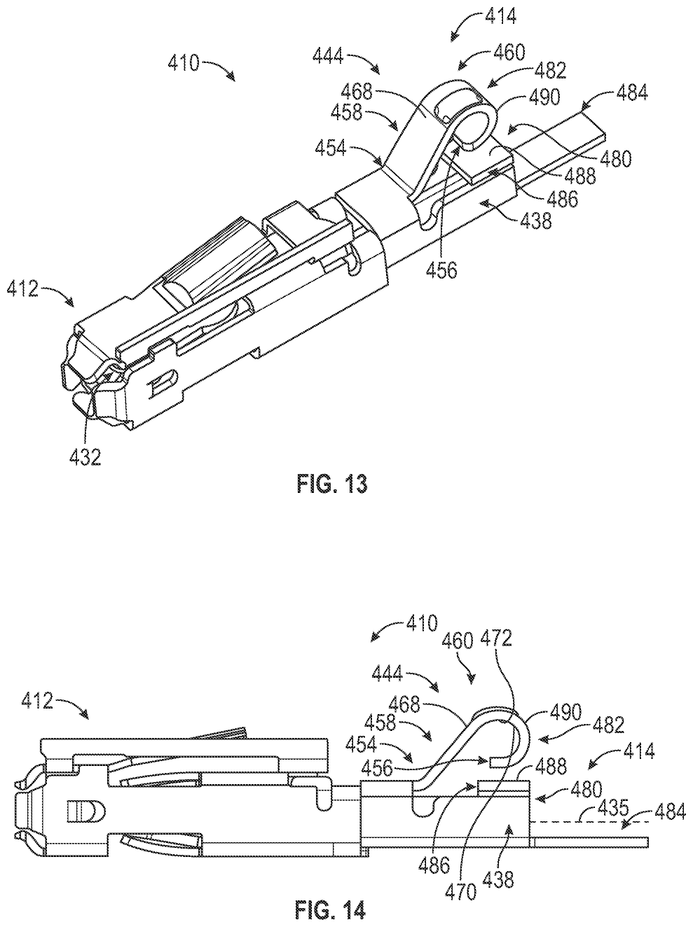

FIGS. 13 and 14 illustrate a third embodiment of an electrical terminal 410 that has a terminal head 412 and an electrical contact 414. In the illustrated embodiment, the electrical contact 414 has a support 480 and the spring finger contact 444 has a tail portion 482 that extends from the contact portion 460. The tail portion 482 contacts the support 480 when the spring finger contact 444 is in the second position, as described in more detail below.

The support 480 has an elongate member 484, a platform 486, and contact surface 488. The elongate member 484 extends from the base 438 of the electrical contact 414 and away from the first end 432 of the electrical contact 414. The platform 486 extends from the elongate member 484 and toward the spring finger contact 444. The contact surface 488 is defined on the platform 486 and is adapted to receive a portion of the spring finger contact 444 (e.g., the tail portion 482).

In the illustrated embodiment, the spring finger contact 444 has a first end 454, a second end 456, a cantilever portion 458, a contact portion 460, a first surface 468, a second surface 470, and a tail portion 482. The first surface 468 opposably faces the second surface 470. The cantilever portion 458 is similar to the cantilever portion 258 and the contact portion 460 is similar to the contact portion 260, as described herein.

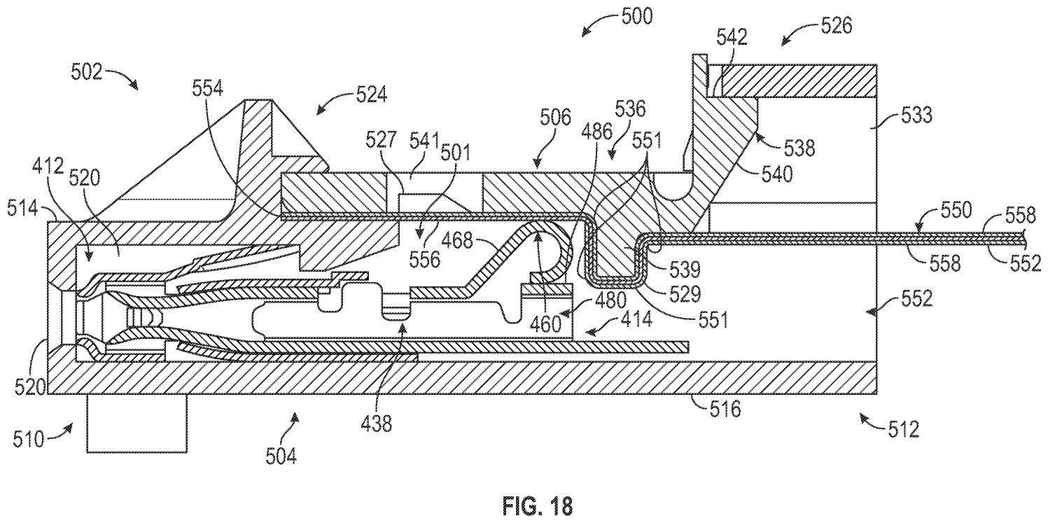

The tail portion 482 extends from the contact portion 460, toward the lengthwise axis 435 of the electrical contact 414, and toward the support 480 (e.g., the platform 486) to the second end 456. In the illustrated embodiment, the tail portion 482 has a fifth, curved portion 490. The fifth, curved portion 490 extends from the fourth, curved portion 472 of the contact portion 460, toward the lengthwise axis 435 of the electrical contact 414, toward the cantilever portion 458, and to the second end 456. In the embodiment illustrated, the spring finger contact 444 is free of contact with the support 480 (e.g., platform 486) when the spring finger contact 444 is in the first position, as shown in FIG. 14, and the spring finger contact 444 contacts the support 480 (e.g., platform 486) when the spring finger contact 444 is in the second position, as shown in FIG. 18, as described in more detail herein.

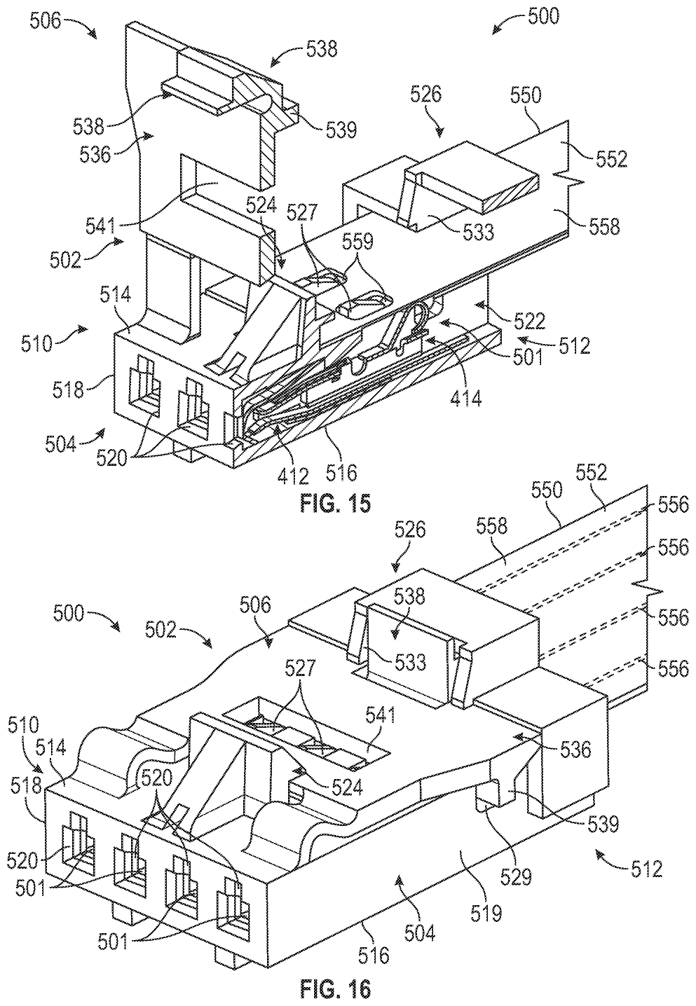

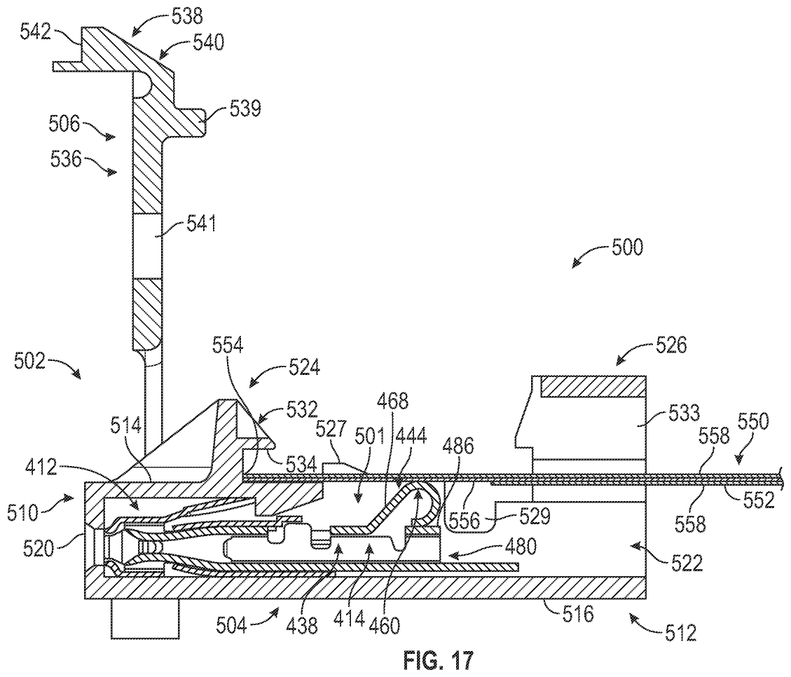

FIGS. 15 through 18 illustrate a third embodiment of an electrical connector assembly 500 that includes a plurality of electrical terminals 501 housed within an electrical connector housing 502. The electrical connector housing 502 is similar to the electrical connector housing 102 illustrated in FIGS. 5 through 7, except as detailed below, and has a base 504 and a cover 506. The cover 506 is moveable between an open position, as shown in FIGS. 15 and 17, and a closed position, as shown in FIGS. 16 and 18.

Each electrical terminal of the plurality of electrical terminals 501 is housed within, and attached to, the electrical connector housing 502. In the illustrated embodiment, each electrical terminal of the plurality of electrical terminals 501 is similar to the electrical terminal 410 illustrated in FIGS. 13 and 14. Each electrical terminal of the plurality of electrical terminals 501 is positioned within the electrical connector housing 502 such that the terminal head 412 is disposed within a passageway of the plurality of passageways 520 and the electrical contact 414 is disposed within a recess of the plurality of recesses 522.

In the illustrated embodiment, the base 504 has a first end 510, a second end 512, a top 514, a bottom 516, a first side 518, a second side 519, a plurality of passageways 520, a plurality of recesses 522, a locking member 524, a retention arm 526, a plurality of projections 527, and a cover recess 529. Each passageway of the plurality of passageways 520 is adapted to receive a portion of an electrical terminal of the plurality of electrical terminals 501 and each recess of the plurality of recesses 522 is adapted to receive a portion of an electrical terminal of the plurality of electrical terminals 501 such that a first portion of an electrical terminal of the plurality of electrical terminals 501 is disposed within a passageway of the plurality of passageways 520 and a second portion of the electrical terminal of the plurality of electrical terminals 501 is disposed within a recess of the plurality of recesses 522. The retention arm 526 extends over the top 514 of the base 504 and over the plurality of recesses 522 and provides a mechanism for maintaining the position of an electrically conductive structure relative to the base 504, as described in more detail herein. The retention arm 526 defines a recess 533 that is adapted to receive a portion of the locking member 538 of the cover 508. Each projection of the plurality of projections 527 extends from the top 514 of the base 504, away from the bottom 516 of the base 504, and is adapted to be received by an opening of the plurality of openings 559 defined by the electrically conductive structure 550, as described in more detail herein, such that the position of the electrically conductive structure 550 can be maintained relative to the electrical connector housing 502 during use. The cover recess 529 extends from the top 514 of the base 504 toward the bottom 516 of the base 504 and from the first side 518 to the second side 519. The cover recess 529 is disposed between the plurality of passageways 520 and the second end 512 of the base and 504. In the embodiment illustrated, the cover recess is disposed between the locking member 524 and the second end 512 of the base 504. The cover recess 529 is adapted to receive a portion of the electrically conductive structure 550 and a portion of the cover 506.

In the illustrated embodiment, the cover 506 is pivotably attached to the base 504 and has a main body 536, a locking member 538, a projection 539, and a passageway 541. The main body 536 is adapted to be disposed between the locking member 524 of the base 504 and the top 514 of the base 504. The locking member 538 extends from the main body 536 and away from the base 504 when the cover 506 is in the closed position and defines a tapered projection 540 and a shoulder 542. The projection 539 extends from the main body 536 and into the cover recess 529 when the cover 506 is in the closed position. The passageway 541 extends through the main body 536 and is adapted to receive each projection of the plurality of projections 527 defined by the base 504 when the cover 506 is in the closed position.

As shown in FIGS. 15 through 18, an electrically conductive structure 550 can be positioned between the base 504 and the cover 506 and attached (e.g., releasably) to the electrical connector housing 502. In the illustrated embodiment, the electrically conductive structure 550 is a flat flexible connector 552 that has an end 554, one or more electrically conductive traces 556 that are surrounded by an outer electrically non-conductive insulator 558, and a plurality of openings 559. A portion of the electrically non-conductive insulator 558 is removed adjacent to, or near, the end 554 of the electrically conductive structure 550 so as to expose the electrically conductive traces 556.

In use, and while the cover 506 is in the open position, the electrically conductive structure 550 is positioned on the base 504 of the electrical connector housing 502 such that each projection of the plurality of projections 527 defined by the base 504 is disposed within an opening of the plurality of openings 559 of the electrically conductive structure 550 and such that each of the electrically conductive traces 556 is disposed adjacent to a spring finger contact 444 of an electrical terminal of the plurality of electrical terminals 501. Subsequently, the cover 506 of the electrical connector housing 502 is moved from the open position to the closed position such that the main body 536 of the cover 506 advances along the tapered projection 532 of the locking member 524 of the base 504 until it is positioned between the shoulder 534 defined by the locking member 524 and the top 514 of the base 504. In addition, when the cover 506 is moved from the open position to the closed position, the locking member 538 of the cover 506 is advanced along the retention arm 526 until the retention arm 526 is positioned within the shoulder 542. As shown in FIG. 18, when the cover 506 is in the closed position, the electrically conductive structure 550 is disposed within the cover recess 529 and defines a plurality of curves 551 between the base 504 and the cover 506, which provides a secondary structure for releasably attaching the electrically conductive structure 550 to the electrical connector housing 502.

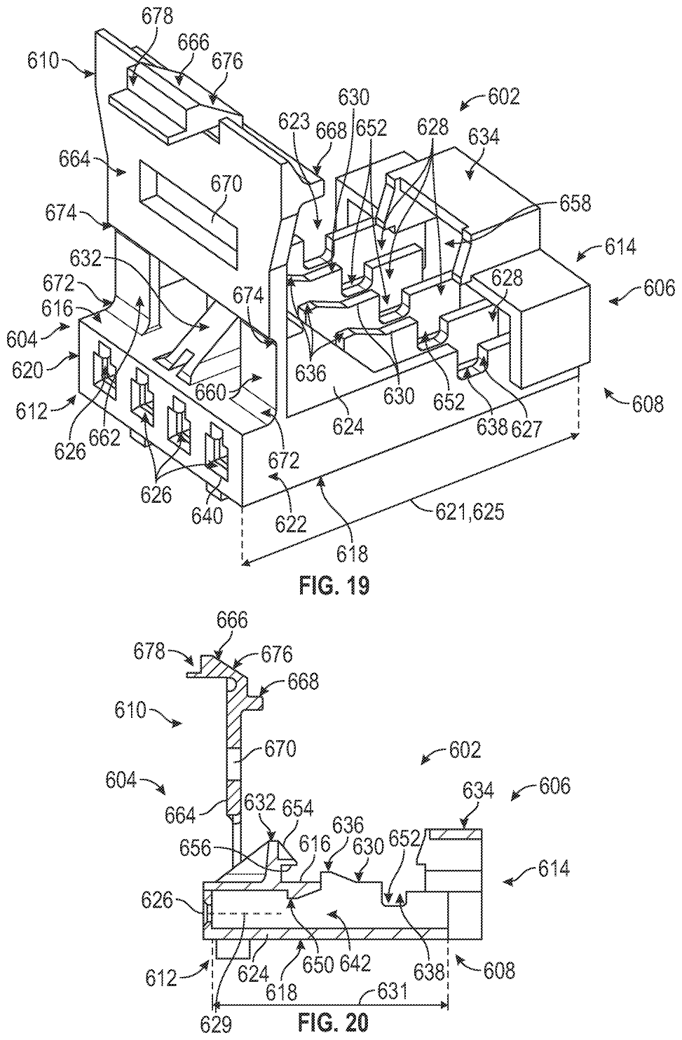

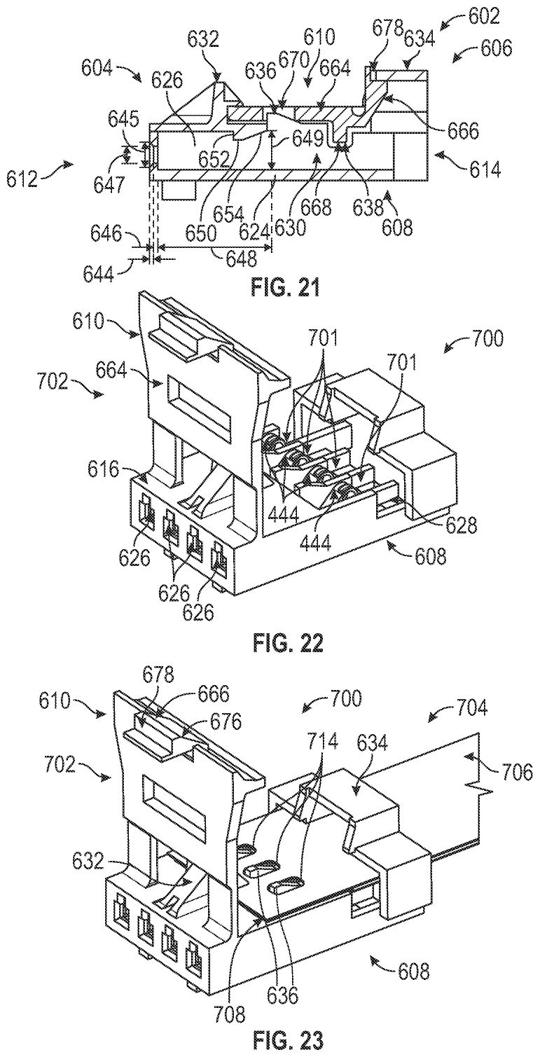

FIGS. 19, 20, and 21 illustrate a third embodiment of an electrical connector housing 602. The electrical connector housing 602 is a dual purpose electrical connector housing 602 in that it can be utilized with the electrical terminals described herein and with conventional electrical terminals (e.g., crimp-style electrical terminals). The electrical connector housing 602 is similar to the electrical housing 502 illustrated in FIGS. 15 through 18, except as detailed below. The electrical connector housing 602 has a first end 604, a second end 606, a base 608, and a cover 610. The cover 610 is moveable between an open position, as shown in FIGS. 19 and 20, and a closed position, as shown in FIG. 21.

In the illustrated embodiment, the base 608 has a first end 612, a second end 614, a top 616, a bottom 618, a first side 620, a second side 622, and a main body 624 that defines a plurality of passageways 626, a plurality of recesses 628, a plurality of separating walls 630, a locking member 632, a retention arm 634, a plurality of projections 636, and a cover recess 638. The first side 620 has a length 621 and defines a recess 623. The second side 622 has a length 625 and defines recess 627.

Each passageway of the plurality of passageways 626 extends from the first end 604 of the electrical connector housing 602 toward the second end 606 of the electrical connector housing 602. Each passageway of the plurality of passageways 626 extends from a first opening 640 on the first end 612 of the base 608 to a second opening 642 that is in communication with a recess of the plurality of recesses 628. Each passageway of the plurality of passageways 626 has a first portion 644, a second portion 646, and a third portion 648. The first portion 644 extends from the first opening 640 to the second portion 646, has a first inside diameter 645 at the first end 612 of the base 608, and an inside diameter that tapers from the first end 612 of the base 608 to the second portion 646. The second portion 646 extends from the first portion 644 to the third portion 648 and has a second inside diameter 647 that is constant along the second portion 646. The third portion 648 extends from the second portion 646 to a recess of the plurality of recesses 628 and has a third inside diameter 649 that is greater than the second inside diameter 647. While particular diameters have been illustrated for the various portions of a passageway of the plurality of passageways 626, a passageway can have any suitable diameter along any suitable portion of the passageway.

As shown in FIGS. 20 and 21, the main body 624 defines a retaining member projection 650 in each passageway of the plurality of passageways 626 that extends towards the center 629 of the passageway of the plurality of passageways 626 within which it is disposed. The retaining member projection 650 has a shoulder 652 and a tapered portion 654 and assists with attachment of an electrical terminal to the base 608, as described herein.

Each recess of the plurality of recesses 628 extends from the top 616 of the base 608 toward the bottom 618 of the base 608 and from a passageway of the plurality of passageways 626 to the second end 614 of the base 608. In the embodiment illustrated, the plurality of passageways 626 includes four passageways and the plurality of recesses 628 includes four recesses. Each passageway of the plurality of passageways 626 is adapted to receive a portion of an electrical terminal and each recess of the plurality of recesses 628 is adapted to receive a portion of an electrical terminal and/or an electrically conductive structure. As described in more detail herein, and as a result of the structural arrangement between the plurality of passageways 626 and the plurality of recesses 628, a first portion of an electrical terminal is disposed within a passageway of the plurality of passageways 626 and a second portion of the electrical terminal is disposed within a recess of the plurality of recesses 628 when an electrical connector assembly is assembled.

In the embodiment illustrated, each separating wall of the plurality of separating walls 630 has a length 631, defines a recess 652, and includes a projection of the plurality of projections 636. As shown in FIG. 19, a separating wall of the plurality of separating walls 630 is disposed between adjacent recesses of the plurality of recesses 628. The length 631 of each separating wall of the plurality of separating walls 630 is less than the length 621 of the first side 620 and the length 625 of the second side 622 of the base 608. However, in alternative embodiments, a separating wall can have any suitable length, such as those that are equal to, or greater than, a length of a side of an electrical connector housing. The recesses 652 defined by the plurality of separating walls 630 cooperatively define the cover recess 638 with the recess 623 defined by the first side 620 and the recess 627 defined by the second side 622. However, depending on the number of passageways and recesses defined by a housing, in alternative embodiments a cover recess can be cooperatively defined only by a recess defined by a first side and a recess defined by a second side.

The locking member 632 extends from the top 616 of the base 608 and away from the bottom 618 of the base 608 and defines a tapered projection 654 and a shoulder 656. The retention arm 634 extends from the first side 620 to the second side 622 of the base 608, extends over the top 616 of the base 608 and the plurality of recesses 628, and provides a mechanism for maintaining the position of an electrically conductive structure relative to the base 608. The retention arm 634 defines a recess 658 that is adapted to receive a portion of the locking member 666 of the cover 610. Each projection of the plurality of projections 636 extends from a separating wall of the plurality of separating walls 630, extends from the top 616 of the base 608 away from the bottom 618 of the base 608, and is adapted to be received by an opening defined by the electrically conductive structure such that the position of the electrically conductive structure can be maintained relative to the electrical connector housing 602 during use. The cover recess 638 is cooperatively defined by the recess 623 of the first side 620, the recess 627 of the second side 622, and the recesses 652 defined by the plurality of separating walls 630 and extends from the first side 620 to the second side 622. However, in alternative embodiments, a cover recess can be cooperatively defined by any suitable portion of an electrical connector housing. The cover recess 638 is disposed between the locking member 632 and the second end 614 of the base 608. The cover recess 638 is adapted to receive a portion of an electrically conductive structure and a portion of the cover 610.

In the embodiment illustrated, the cover 610 is pivotably attached to the base 608 and has a first support member 660, a second support member 662, a main body 664, a locking member 666, a projection 668, and a passageway 670. Each of the first support member 660 and the second support member 662 has a first end 672 and a second end 674. The first end 672 is attached to the base 608 and the second end 674 is attached to the main body 664. The main body 664 is adapted to be partially disposed between the locking member 632 of the base 608 and the top 616 of the base 608 and is adapted to position a portion of an electrically conductive structure between the cover 610 and the base 608 when the cover 610 is in the closed position. The locking member 666 extends from the main body 664 and away from the base 608 when the cover 610 is in the closed position and defines a tapered projection 676 and a shoulder 678. The projection 668 extends from the main body 664 and towards the base 608 when the cover 610 is in the closed position. The projection 668 is disposed within the cover recess 638 when the cover 610 is in the closed position. The passageway 670 extends through the main body 664 and is adapted to receive each projection of the plurality of projections 636 defined by the base 608 when the cover 610 is in the closed position.

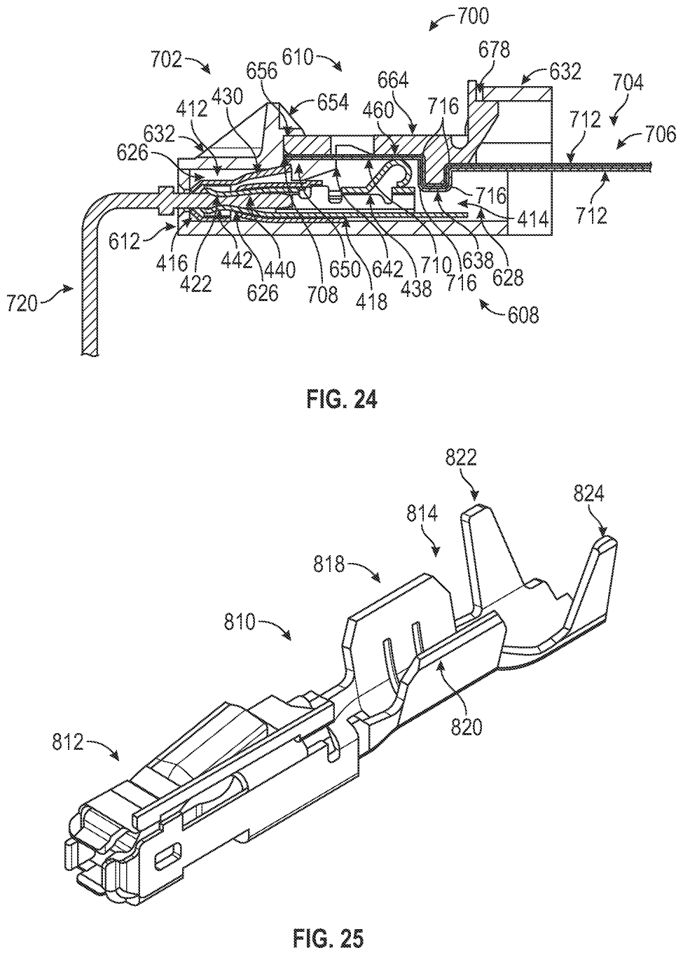

FIGS. 22 through 24 illustrate a fourth embodiment of an electrical connector assembly 700 that includes a plurality of electrical terminals 701 housed within an electrical connector housing 702. The electrical connector housing 702 is similar to the electrical connector housing 602 illustrated in FIGS. 19 through 21 and has a base 608 and a cover 610. The cover 610 is moveable between an open position, as shown in FIGS. 22 and 23, and a closed position, as shown in FIG. 24.

Each electrical terminal of the plurality of electrical terminals 701 is housed within, and attached to, the electrical connector housing 702. In the illustrated embodiment, each electrical terminal of the plurality of electrical terminals 701 is similar to the electrical terminal 410 illustrated in FIGS. 13 and 14.

Each electrical terminal of the plurality of electrical terminals 701 is positioned within the electrical connector housing 702 such that the terminal head 412 is disposed within a passageway of the plurality of passageways 626 and the electrical contact 414 is disposed within a recess of the plurality of recesses 628. As shown in FIG. 22, the spring finger contact 444 of each electrical terminal of the plurality of electrical terminals 701 is positioned such that it is partially disposed within a recess of the plurality of recesses 628, partially extends beyond the boundaries of the recess of the plurality of recesses 628, and partially extends beyond the top 616 of the base 608 when in the first position. This structural arrangement allows the spring finger contact 444 to contact an electrically conductive structure, as described in more detail herein. In the embodiment illustrated, the plurality of electrical terminals 701 includes four electrical terminals.

To position an electrical terminal of the plurality of electrical terminals 701 within the electrical connector housing 702, the first end 416 of the terminal head 412 is aligned with the second opening 642 of a passageway of the plurality of passageways 626 defined by the base 608. An axial force is applied to one or both of the electrical terminal of the plurality of electrical terminals 701 and the electrical connector housing 702 directed toward the other component or each other such that the terminal head 412 is advanced into the passageway of the plurality of passageways 626 defined by the base 608 and the retaining projection 430 of the terminal head 412 is disposed between the retaining member projection 650 and the first end 612 of the base 608. In the illustrated embodiment, the retaining projection 430 moves from the first position to the second position (e.g., deflects) as the terminal head 412 moves relative to the electrical connector housing 702 and into the passageway of the plurality of passageways 626. Subsequently, after the retaining projection 430 is advanced to a position in which it is disposed between the retaining member projection 650 and the first end 612 of the base 608, the retaining projection 430 moves back to the first position as a result of its bias to the first position.

As shown in FIGS. 23 and 24, an electrically conductive structure 704 can be positioned between the base 608 and the cover 610 and attached (e.g., releasably) to the electrical connector housing 702. In the illustrated embodiment, the electrically conductive structure 704 is a flat flexible connector 706 that has an end 708, one or more electrically conductive traces 710 that are surrounded by an outer electrically non-conductive insulator 712, and a plurality of openings 714. A portion of the electrically non-conductive insulator 712 is removed adjacent to, or near, the end 708 of the electrically conductive structure 704 so as to expose the electrically conductive traces 710. In the embodiment illustrated, the electrically conductive structure 704 includes four electrically conductive traces 710.

In use, and while the cover 610 is in the open position, the electrically conductive structure 704 is positioned on the base 608 of the electrical connector housing 702 such that each projection of the plurality of projections 636 defined by the base 608 is disposed within an opening of the plurality of openings 714 of the electrically conductive structure 704 and such that each of the electrically conductive traces 710 is disposed adjacent to a spring finger contact 444 of an electrical terminal of the plurality of electrical terminals 701. Subsequently, the cover 610 of the electrical connector housing 702 is moved from the open position to the closed position such that the main body 664 of the cover 610 traverses the tapered projection 654 of the locking member 632 of the base 608 and is positioned between the shoulder 656 defined by the locking member 632 and the top 616 of the base 608. In addition, when the cover 610 is moved from the open position to the closed position, the tapered projection 676 of the locking member 666 of the cover 610 traverses the retention arm 634 such that the retention arm 634 is positioned within the shoulder 678. As shown in FIG. 24, when the cover 610 is in the closed position, the electrically conductive structure 704 is disposed within the cover recess 638 and defines a plurality of curves 716 between the base 608 and the cover 610 and each of the electrically conductive traces 710 contacts a contact portion 460 of an electrical terminal of the plurality of electrical terminals 701.

Subsequently, as shown in FIG. 24, a second electrically conductive structure 720 can be advanced into a passageway of the plurality of passageways 626 and into a passageway 422 of a terminal head 412, from the first end 416 of the terminal head 412 toward the second end 418 of the terminal head 412, until the second electrically conductive structure 720 contacts a portion of the terminal head 412 and/or the electrical contact 414 (e.g., first retaining arm 440 and/or second retaining arm 442). As a result, an electrically conductive connection between the electrical terminal of the plurality of electrical terminals 701 and the second electrically conductive structure 720 is accomplished. When the cover 610 is moved from the closed position to the open position, and the electrically conductive structure 704 is withdrawn from the electrical connector housing 702, the spring finger contact 444 moves from its second position to its first position.

FIG. 25 illustrates a conventional electrical terminal 810 (e.g., crimp-style electrical terminal) that has a terminal head 812 and an electrical contact 814. The terminal head 812 is similar to the terminal head 412 of the electrical terminal 410 illustrated in FIGS. 13 and 14. The electrical contact 814 comprises first and second wings 818, 820 and third and fourth wings 822, 824. The first and second wings 818, 820 are adapted to be crimped onto an electrically conductive material of an electrically conductive structure, as described in more detail herein. The third and fourth wings 822, 824 are adapted to be crimped onto a non-conductive insulator of an electrically conductive structure, as described in more detail herein, to accomplish attachment between the electrical terminal 810 and an electrically conductive structure.

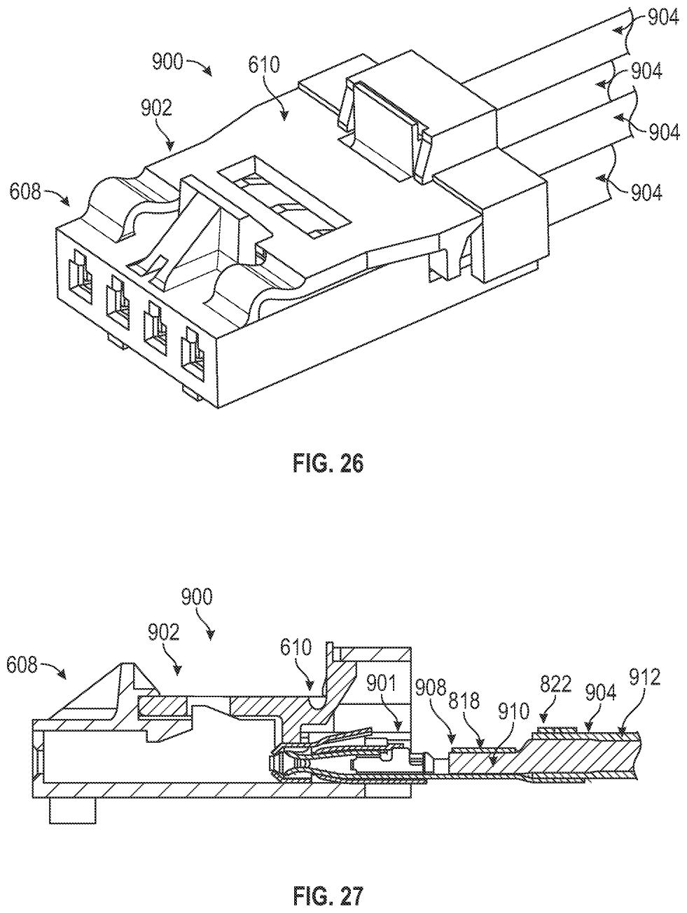

FIGS. 26 through 28 illustrate a fifth embodiment of an electrical connector assembly 900 that includes a plurality of electrical terminals 901 housed within an electrical connector housing 902. The electrical connector housing 902 is similar to the electrical connector housing 602 illustrated in FIGS. 19 through 21 and has a base 608 and a cover 610. The cover 610 is moveable between an open position and a closed position, as shown in FIGS. 26, 27, and 28. Each electrical terminal of the plurality of electrical terminals 901 is housed within, and attached to, the electrical connector housing 902. In the illustrated embodiment, each electrical terminal of the plurality of electrical terminals 901 is similar to the electrical terminal 810 illustrated in FIG. 25.

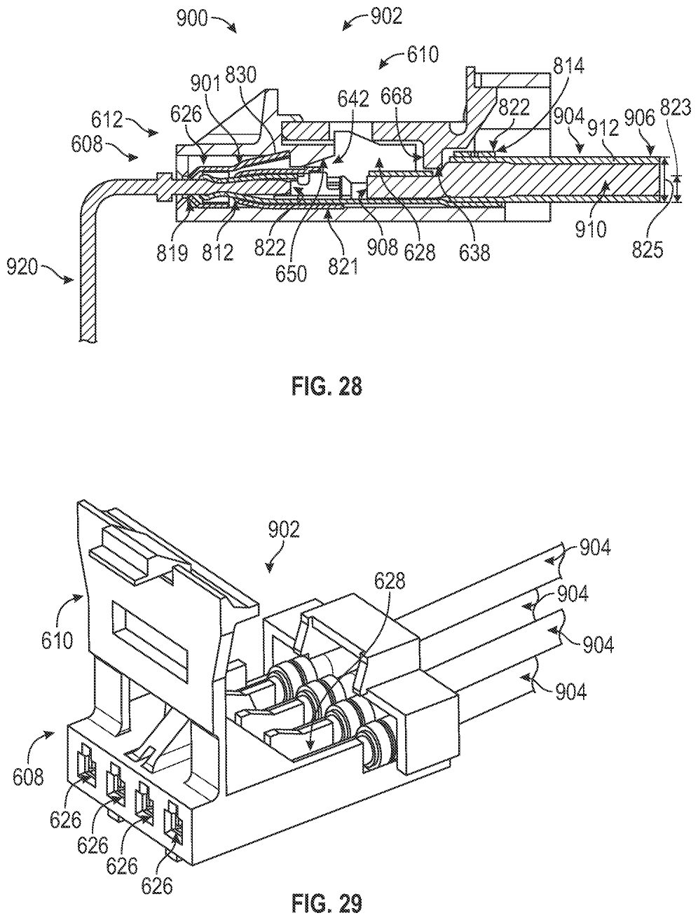

As shown in FIGS. 26 and 28, a plurality of electrically conductive structures 904 are releasably connected to the electrical connector housing 902. In the embodiment illustrated, each electrically conductive structure of the plurality of electrically conductive structures 904 has an end 908, an electrically conductive material 910 that is surrounded by an outer electrically non-conductive insulator 912. A portion of the electrically non-conductive insulator 912 is removed adjacent to, or near, the end 908 of the electrically conductive structure 904 so as to expose the electrically conductive material 910. In the embodiment illustrated, the plurality of electrically conductive structures 904 includes four electrically conductive structures.

Prior to being positioned within the electrical connector housing 902, each electrically conductive structure of the plurality of electrically conductive structures 904 is attached to an electrical terminal of the plurality of electrical terminals 901. This is accomplished by positioning the electrically conductive material 910 of an electrically conductive structure between the first and second wings 818, 820 of an electrical terminal of the plurality of electrical terminals 901 and positioning the non-conductive insulator 912 between the third and fourth wings 822, 824 of the electrical terminal of the plurality of electrical terminals 901. Subsequently, the first and second wings 818, 820 are crimped on the electrically conductive material 910 and the third and fourth wings 822, 824 are crimped on the non-conductive insulator 912 to accomplish attachment between the electrically conductive structure and the electrical terminal of the plurality of electrical terminals 901. The portion of the electrical contact 814 within which the electrically conductive material 910 is disposed has a first outside diameter 823 and the portion of the electrical contact 814 within which the non-conductive insulator 912 is disposed has a second outside diameter 825 that is greater than the first outside diameter 823. This process can be repeated any suitable number of times depending on the number of electrical terminals intended to be disposed within an electrical connector housing.

Each electrical terminal of the plurality of electrical terminals 901 is positioned within the electrical connector housing 902 such that the electrical terminal is disposed between the base 608 and the cover 610, the terminal head 812 is disposed within a passageway of the plurality of passageways 626, and the electrical contact 814 is disposed within a recess of the plurality of recesses 628. In the embodiment illustrated, the plurality of electrical terminals 901 includes four electrical terminals.

As shown in FIGS. 27 and 28, to position an electrical terminal of the plurality of electrical terminals 901 within the electrical connector housing 901, the cover 610 is moved to the closed position and the first end 819 of the terminal head 812 is aligned with a recess of the plurality of recesses 628 and the second opening 642 of a passageway of the plurality of passageways 626 defined by the base 608. An axial force is applied to one or both of the electrical terminal of the plurality of electrical terminals 901 and the electrical connector housing 902 directed toward the other component or each other such that the terminal head 812 is advanced into the recess of the plurality of recesses 628 and the passageway of the plurality of passageways 626 defined by the base 608 and the retaining projection 830 of the terminal head 812 is disposed between the retaining member projection 650 and the first end 612 of the base 608. In the illustrated embodiment, the retaining projection 830 moves from the first position to the second position (e.g., deflects) as the terminal head 812 moves relative to the electrical connector housing 902 and into the passageway of the plurality of passageways 626. Subsequently, after the retaining projection 830 is advanced to a position in which it is disposed between the retaining member projection 650 and the first end 612 of the base 608, the retaining projection 830 moves back to the first position as a result of its bias to the first position.

As shown in FIG. 28, an electrically conductive structure 906 of the plurality of electrically conductive structures 904 is positioned between the base 608 and the cover 610 and attached (e.g., releasably) to the electrical connector housing 902. When the cover 610 is in the closed position, the electrically conductive structure 906 is partially disposed within the cover recess 638 such that the portion of the electrical contact 814 within which the non-conductive insulator 912 is disposed is positioned between the projection 668 of the cover 610 and the second end 614 of the base 610.

Subsequently, as shown in FIG. 28, a second electrically conductive structure 920 can be advanced into a passageway of the plurality of passageways 626 and into a passageway 822 of a terminal head 812, from the first end 819 of the terminal head 812 toward the second end 821 of the terminal head 812, until the second electrically conductive structure 920 contacts a portion of the terminal head 812 and/or the electrical contact 814. As a result, an electrically conductive connection between the electrical terminal of the plurality of electrical terminals 901 and the second electrically conductive structure 920 is accomplished.

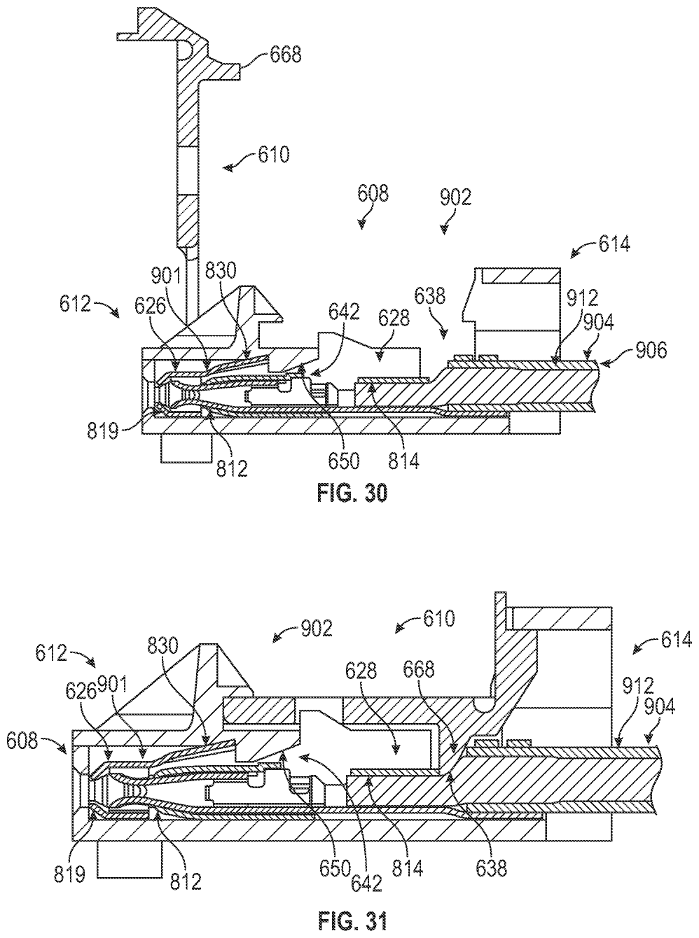

FIGS. 29 through 31 illustrate an alternative method for positioning the plurality of electrically conductive structures 904 within the fifth embodiment of an electrical connector assembly 900. Each electrical terminal of the plurality of electrical terminals 901 is positioned within the electrical connector housing 902 such that the terminal head 812 is disposed within a passageway of the plurality of passageways 626 and the electrical contact 814 is disposed within a recess of the plurality of recesses 628. As shown in FIGS. 30 and 31, to position an electrical terminal of the plurality of electrical terminals 901 within the electrical connector housing 902, the cover 610 is moved to the open position and the first end 819 of the terminal head 812 is aligned with a recess of the plurality of recesses 628 and the second opening 642 of a passageway of the plurality of passageways 626 defined by the base 608. An axial force is applied to one or both of the electrical terminal of the plurality of electrical terminals 901 and the electrical connector housing 902 directed toward the other component or each other such that the terminal head 812 is advanced into the recess of the plurality of recesses 628 and the passageway of the plurality of passageways 626 defined by the base 608 and the retaining projection 830 of the terminal head 812 is disposed between the retaining member projection 650 and the first end 612 of the base 608. Subsequently, the cover 610 is moved from the open position to the closed position such that an electrically conductive structure 906 is positioned between the base 608 and the cover 610 and attached (e.g., releasably) to the electrical connector housing 902. When the cover 610 is in the closed position, the electrically conductive structure 906 is partially disposed within the cover recess 638 such that the portion of the electrical contact 814 within which the non-conductive insulator 912 is disposed is positioned between the projection 668 of the cover 610 and the second end 614 of the base 610.

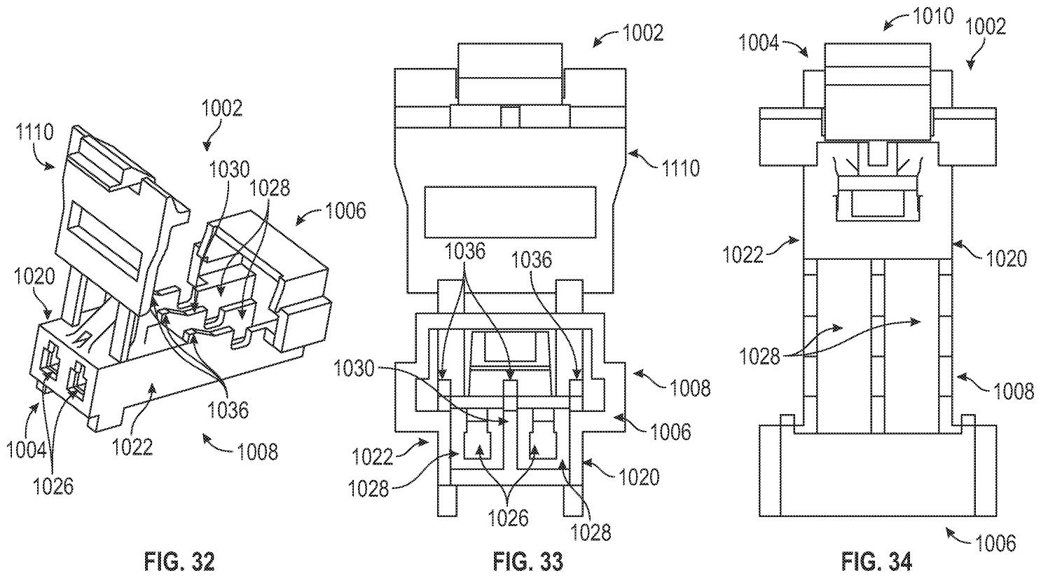

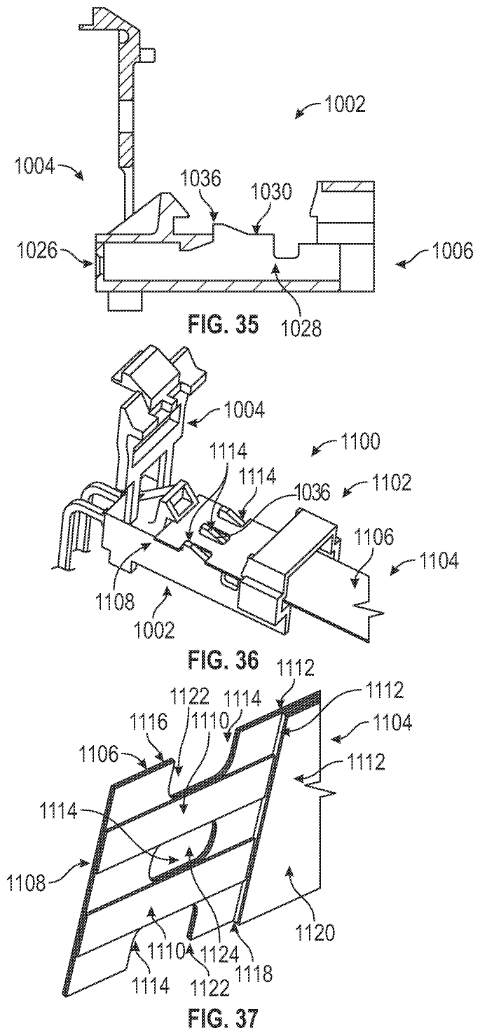

FIGS. 32 through 35 illustrate a fourth embodiment of an electrical connector housing 1002. The electrical connector housing 1002 is a dual purpose electrical connector housing 1002 in that it can be utilized with the electrical terminals described herein and with conventional electrical terminals (e.g., crimp-style electrical terminals). The electrical connector housing 1002 is similar to the electrical housing 602 illustrated in FIGS. 19, 20, and 21, except as detailed below. The electrical connector housing 1002 has a first end 1004, a second end 1006, a base 1008, and a cover 1010. The cover 1010 is moveable between an open position, as shown in FIGS. 32 through 35, and a closed position.

In the embodiment illustrated, the plurality of passageways 1026 defined by the base 1008 includes two passageways, the plurality of recesses 1028 defined by the base 1008 includes two recesses, the base 1008 defines a single separating wall 1030, and the plurality of projections 1036 includes three projections. A projection of the plurality of projections 1036 is defined by each of the first side 1020 and the second side 1022 and a projection of the plurality of projections 1036 is defined by the separating wall 1030.

FIG. 36 illustrates a fifth embodiment of an electrical connector assembly 1100 that includes a plurality of electrical terminals housed within an electrical connector housing 1102. The electrical connector housing 1102 is similar to the electrical connector housing 1002 illustrated in FIGS. 32 through 35 and has a base 1002 and a cover 1004. As shown in FIG. 36, an electrically conductive structure 1104 is positioned on the base 1008 and can be releasably attached to the electrical connector housing 1102, as described herein.

As shown in FIGS. 36 and 37, the electrically conductive structure 1104 is a flat flexible connector 1106 that has an end 1108, one or more electrically conductive traces 1110 that are surrounded by an outer electrically non-conductive insulator 1112, and a plurality of openings 1114. A portion of the electrically non-conductive insulator 1112 is removed adjacent to, or near, the end 1108 of the electrically conductive structure 1104 so as to expose the electrically conductive traces 1110.

In the embodiment illustrated, the electrically conductive structure 1104 includes two electrically conductive traces 1110. The electrically non-conductive insulator 1112 includes a top layer 1116, an intermediate layer 1118, and a bottom layer 1120. Each of the top layer 1116, the intermediate layer 1118, and the bottom layer 1120 is formed of a different material. However, in alternative embodiments each of a top layer, an intermediate layer, and a bottom layer can be formed of the same material. Each opening of the plurality of openings 1114 is defined on the top layer 1116. The plurality of openings 1114 includes two partial enclosed openings 1122 and one entirely enclosed opening 1124. However, alternative embodiments can include any suitable number and type of openings. The intermediate layer 1118 has a length that is less than a length of the top layer 1116. Each of the electrically conductive traces 1110 is disposed between the top layer 1116 and the bottom layer 1120, within the intermediate layer 1118, and has a length that is greater than the length of the intermediate layer 1118. In the illustrated embodiment, each of the electrically conductive traces 1110 has a length that is substantially equal to the length of the top layer 1118. However, alternative embodiments can include an electrically conductive trace that has a length that is less than a length of a top layer. The bottom layer 1120 has a length that is less than a length of the top layer 1116.

In use, and while the cover 1010 is in the open position, the electrically conductive structure 1104 is positioned on the base 1008 of the electrical connector housing 1102 such that each projection of the plurality of projections 1036 defined by the base 1008 is disposed within an opening of the plurality of openings 1114 of the electrically conductive structure 1104 and such that each of the electrically conductive traces 1110 is disposed adjacent to a spring finger contact of an electrical terminal of the plurality of electrical terminals. Subsequently, the cover 1010 of the electrical connector housing 1102 is moved from the open position to the closed position such that the each electrical terminal of the plurality of electrical terminals contacts and engages a trace of the electrically conductive traces 1110 to accomplish an electrically conductive connection between the trace and the electrical terminal.

Use of the electrical connector housings and electrical connector assemblies described herein provide a mechanism for attaching an electrically conductive structure to various types of electrical terminals (e.g., electrical terminals that do not require a crimped connection between the electrical terminal and the electrically conductive structure, crimp-style electrical terminals), which can result in a decrease in the complexity and time required to make an electrical connection between an electrical terminal and an electrically conductive structure. In addition, in embodiments in which a conventional crimp-style electrical terminal is used, the dual purpose housings described herein provide a secondary structure for releasably attaching the electrical terminal to the electrical connector housing.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector housing comprising:
a base having a first end, a second end, a passageway, a recess, and a cover recess, the passageway extending from the first end of the base toward the second end of the base, the recess extending from the passageway to the second end of the base, the cover recess disposed between the passageway and the second end of the base; and
a cover moveable between an open position and a closed position relative to the base, the cover having a projection disposed within the cover recess when the cover is in the closed position.

2. The electrical connector housing of claim 1, wherein the base has a first side and a second side, the first side defining a recess, the second side defining a recess, the recess of the first side and the recess of the second side cooperatively defining the cover recess.

3. The electrical connector housing of claim 1, further comprising a retaining member projection extending into the passageway.

4. The electrical connector housing of claim 1, wherein the base has a top, a bottom, a locking member, and a retention arm, the locking member extending from the top of the base and away from the bottom of the base, the retention arm extending over the recess of the base, the retaining arm defining a recess.

5. The electrical connector housing of claim 4, wherein the locking member defines a tapered projection and a shoulder.

6. The electrical connector housing of claim 4, wherein the cover has a locking member; and
wherein the recess defined by the retention arm is adapted to receive a portion of the locking member of the cover.

7. The electrical connector housing of claim 1, wherein the base has a plurality of passageways, each passageway of the plurality of passageways extending from the first end of the base toward the second end of the base.

8. The electrical connector housing of claim 7, wherein the base has a plurality of recesses, each recess of the plurality of recesses extending from a passageway of the plurality of passageways to the second end of the base.

9. The electrical connector housing of claim 8, wherein the base has a separating wall disposed between adjacent recesses of the plurality of recesses.

10. The electrical connector housing of claim 9, wherein the base has a first side and a second side, the first side defining a recess, the second side defining a recess;
wherein the separating wall has a recess; and
wherein the recess of the separating wall, the recess of the first side, and the recess of the second side cooperatively define the cover recess.

11. The electrical connector housing of claim 10, wherein the base has a plurality of projections, a projection of the plurality of projections defined on the separating wall, a projection of the plurality of projections defined on the first side, a projection of the plurality of projections defined on the second side.

12. The electrical connector housing of claim 11, wherein the cover defines a passageway; and
wherein each projection of the plurality of projections is disposed within the cover passageway when the cover is in the closed position.

13. An electrical connector assembly comprising:
an electrical connector housing having a base and a cover, the base having a first end, a second end, a passageway, a recess, and a cover recess, the passageway extending from the first end of the base toward the second end of the base, the recess extending from the passageway to the second end of the base, the cover recess disposed between the passageway and the second end of the base, the cover moveable between an open position and a closed position relative to the base, the cover having a projection disposed within the cover recess when the cover is in the closed position; and
an electrical terminal having a terminal head and an electrical contact, the terminal head disposed within the passageway of the base, the electrical contact disposed within the recess of the base.

14. The electrical connector assembly of claim 13, wherein the electrical contact extends from the terminal head and has a lengthwise axis and a spring finger contact, the spring finger contact moveable relative to the terminal head between a first position and a second position, the spring finger contact in the first position when the cover is in the open position, the spring finger contact in the second position when the cover is in the closed position, the spring finger contact having a cantilever portion and a contact portion, the cantilever portion extending away from the terminal head and away from the lengthwise axis of the electrical contact, the contact portion extending from the cantilever portion.

15. The electrical connector assembly of claim 14, wherein the electrical contact has a support; and
wherein the spring finger contact has a tail portion extending from the contact portion and contacting the support when the spring finger contact is in the second position.

16. The electrical connector assembly of claim 13, further comprising an electrically conductive structure disposed within the electrical connector housing between the base and the cover.

17. The electrical connector assembly of claim 16, wherein the electrically conductive structure has an electrically conductive trace contacting the contact portion when the cover is in the closed position.

18. The electrical connector assembly of claim 17, wherein the electrically conductive structure comprises an electrically conductive trace surrounded by an electrically non-conductive insulator, the electrically non-conductive insulator having a top layer, an intermediate layer, and a bottom layer, the electrically conductive trace disposed between the top layer and the bottom layer and contacting the contact portion when the cover is in the closed position.

19. The electrical connector assembly of claim 17, wherein said electrically conductive structure is a flat flexible connector.

20. An electrical connector assembly comprising:
an electrical connector housing having a base and a cover, the base having a first end, a second end, a passageway, a recess, and a cover recess, the passageway extending from the first end of the base toward the second end of the base, the recess extending from the passageway to the second end of the base, the cover recess disposed between the passageway and the second end of the base, the cover moveable between an open position and a closed position relative to the base, the cover having a projection disposed within the cover recess when the cover is in the closed position;
an electrical terminal having a terminal head and an electrical contact, the terminal head disposed within the terminal passageway of the base, the electrical contact disposed within the terminal recess, the electrical contact extending from the terminal head and having a lengthwise axis and a spring finger contact, the spring finger contact moveable relative to the terminal head between a first position and a second position, the spring finger contact in the first position when the cover is in the open position, the spring finger contact in the second position when the cover is in the closed position, the spring finger contact having a cantilever portion and a contact portion, the cantilever portion extending away from the terminal head and away from the lengthwise axis of the electrical contact, the contact portion extending from the cantilever portion; and
an electrically conductive structure disposed within the electrical connector housing between the base and the cover, the electrically conductive structure comprising an electrically conductive trace surrounded by an electrically non-conductive insulator, the electrically non-conductive insulator having a top layer, an intermediate layer, and a bottom layer, the electrically conductive trace disposed between the top layer and the bottom layer and contacting the contact portion when the cover is in the closed position.
